(19) United States
(12) Patent Application Publication
(10) Pub. No.: US 2010/0110112 A1
(43) Pub. Date: May 6, 2010

(54) BACKLIGHT APPARATUS AND DISPLAY APPARATUS

(75) Inventor: Hideyuki NAKANISHI, Osaka (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Osaka (JP)

(21) Appl. No.: 12/606,815

(22) Filed: Oct. 27, 2009

(30) Foreign Application Priority Data
Oct. 28, 2008 (JP) 2008-276401
Oct. 7, 2009 (JP) 2009-233591

(51) Int. Cl. G09G 5/10

(52) U.S. Cl. 345/690

(57) ABSTRACT

The backlight apparatus allows brightness control with minimum image quality deterioration. This apparatus (1) has: an illuminating section (20) that radiates illuminating light on a liquid crystal panel (10); a brightness determining section (30) that determines a light emission brightness value of the illuminating section (20) and updates a light emitting state of the illuminating section (20), based on this light emission brightness value; and an update controlling section (40) that controls a timing to update the light emission brightness value, and the illuminating section (20) has a plurality of light emitting areas illuminating each of a plurality of image display areas, the brightness determining section (30) determines a light emission brightness value of the first image display area, from values acquired by applying weights to the first information based on an input image signal of the first image display area and the second information based on the input image signal of the second image display areas and the update controlling section (40) makes the brightness determining section (30) update each light emitting state of a plurality of light emitting states a plurality of times while all image display areas of the liquid crystal panel (10) are scanned once according to an input image signal.

### CROSS REFERENCE TO RELATED APPLICATIONS

The disclosures of Japanese Patent Application No. 2008-276401, filed on Oct. 28, 2008, and Japanese Patent Application No. 2009-233591, filed on Oct. 7, 2009, including the specifications, drawings and abstracts, are incorporated herein by reference in their entirety.

### TECHNICAL FIELD

The technical field relates to a backlight apparatus and a display apparatus using this backlight apparatus. More particularly, the technical field relates to a backlight apparatus and display apparatus for controlling the lighting of a plurality of divided areas.

### BACKGROUND ART

Non-self luminous display apparatuses represented by liquid crystal apparatuses have backlight apparatuses (hereinafter, simply “backlight”) in the back. These display apparatuses display images through an optical modulating section. According to image signals, the optical modulating section adjusts the reflectance and transmittance of light radiated from the backlight. To expand the dynamic range of display brightness, these display apparatuses employ a configuration of dividing the illuminating section of the backlight into a plurality of areas and controlling brightness on a per area basis (see, for example, Patent Literature 1 and Patent Literature 2).

With the configuration as described above, in terms of cost, it is difficult to make the number of divisions of the backlight (i.e. the resolution of the backlight) the same as the resolution of the optical modulating section. Accordingly, the resolution of the backlight is usually lower than the resolution of the optical modulating section. Therefore, problems occur due to the difference in the resolutions between the backlight and optical modulating section. One of the problems is the phenomenon where a part that must be displayed black becomes bright and looks distinct (hereinafter, “less deep black”). This problem will be explained below using FIG. 1A to FIG. 1C and FIG. 2A to FIG. 2C.

FIG. 1A to FIG. 1C illustrate the state of “less deep black” in still images. FIG. 1A shows input image 900 (or the state in which modulation is performed in the optical modulating section). In input image 900, there is a circular object with a high peak brightness on a black background. Note that the broken lines on input image 900 indicate the positions of divided areas of the backlight for ease of illustration, and are not included in the input image. According to this input image, the optical modulating section such as a liquid crystal panel is controlled. To be more specific, the aperture ratio of the liquid crystal panel is controlled such that more light transmits in parts of higher brightness.

FIG. 1B shows the light emitting state of backlight 910. Here, backlight 910 has nine divided areas. Here, assume that the above-described circular object is completely included in the area located in the center of backlight 910 (hereinafter simply “center area”). The center area includes a circular object with high peak brightness in input image 900 as described above, and therefore emits light at brightness matching the image of this area. Then, surrounding areas are turned off because the overall images of these areas are black.

FIG. 1C shows display image 920 displayed on the display apparatus. In this way, in the center area, even black part practically allows the small amount of light to transmit. Therefore, the difference in brightness of the black color of the background is produced between the center area and the areas adjacent to this center area. As a result, “less deep black” is produced distinctly in the center area compared to the neighboring areas.

Although a case of still images has been explained with FIG. 1A to FIG. 1C, a case of moving images will be explained using FIG. 2A to FIG. 2C.

FIG. 2A to FIG. 2C illustrate the state of “less deep black” in moving images. FIG. 2A shows that a circular object moves from the left to the right in same input image 900 as in FIG. 1A.

FIG. 2B shows how the light emitting state of backlight 910 transitions. When the circular object moves to the right and crosses over two light emitting areas, both light emitting areas emit light. Therefore, compared to the time the circular object is included in only one light emitting area, the light emitting area becomes larger. Then, when the circular object further moves to the right, the circular object is included in one area again and only one light emitting area emits light.

FIG. 2C shows how display image 920 displayed on the display apparatus transitions. In this way, when an object having different brightness from the surroundings moves, the area of the above-described “less deep black” part changes at the timing the object crosses over light emitting areas. When the area of light emitting areas changes in this way, “less deep black” is more likely to be seen.

As a method of reducing such “less deep black,” for example, Patent Literature 3 discloses a configuration, in brightness control of the backlight, “having a neighboring area lighting means for making a backlight light the areas of a predetermined width adjacent to non-lighting areas, which are adjacent to divided areas illuminated based on an image signal, at lower brightness than brightness of divided areas that are illuminated.”

In addition to this, with the configuration for controlling brightness of each of a plurality of areas in the illuminating section of the backlight, there is a problem that the scan of images and the timing to update brightness of the illuminating section (hereinafter “brightness update timings”) do not match (that is, mismatch). That is, to control brightness on a per light emitting area basis, the timings to update brightness of light emitting areas and the timings to overwrite the pixels of the liquid crystal panel need to match. If these timings do not match, a mismatch between an image and brightness of the backlight occurs when the image changes, thereby resulting in deterioration of the image. This will be explained using FIG. 3A to FIG. 3C.

FIG. 3A to FIG. 3C illustrate a mismatch between an image and brightness of the backlight. Here, time t0 is the time after all items of data in an N-th frame have been scanned. Time t1 is the time after one third of an N+1-th frame has been scanned. Time t2 is the time after two thirds of the N+1-th frame has been scanned. Time t3 is the time after all items of data in the N+1-th frame have been scanned.

FIG. 3A shows how input image 800 transitions. In input image 800, three rectangular objects with high peak brightness are aligned vertically on a black background. Note that the broken lines on input image 800 indicate the positions of divided areas of the backlight for ease of illustration, and are not included in the input image. According to this input image, the optical modulating section such as a liquid crystal panel is controlled.

In FIG. 3A, an input image transitions to next frame images in steps at times t0 to t3. That is, images after all items of data in an N-th frame are scanned at time t0 shown on the leftmost side, transition to images after all items of data in the N+1-th frame are scanned at time t3 shown on the rightmost side. For example, after one third of an N+1-th frame is scanned, upper one third of the input image transitions to the image of the N+1-th frame and the rest of the input image shows the images of the N-th frame. Similarly, after two thirds of the N+1-th frame is scanned, upper two thirds of the input image transitions to the image of the N+1-th frame and the rest of the input image remains as the image of the N-th frame.

FIG. 3B shows how the light emitting state of backlight 810 transitions. Here, backlight 810 has nine divided areas. The areas located in left one third of backlight 810 include rectangular objects with high peak brightness in input image 800, and therefore emit light at brightness matching the image in these areas. Then, other areas are turned off because the overall images of these areas are black. The timings to update brightness of the backlight match with timings to finish scanning all items of data in one frame. Therefore, backlight 810 emits light in the same state by time t2, and updates brightness at time t3.

FIG. 3C shows how display image 820 displayed on the display apparatus transitions. That is, the aperture ratio of the liquid crystal panel and brightness of the backlight are combined to show a display image that is actually seen. Here, for example, at time t1 and time t2, a mismatch between the timing to scan an image and the timing to update brightness of the backlight occurs. When this mismatch occurs, with the example of FIG. 3C, the white rectangular objects are shown at low brightness, and trailing tails are shown because the white rectangular objects do not match the operation of the backlight.

As a method of reducing the problem due to this mismatch, for example, Patent Literature 4 discloses a method of adjusting the timings to update brightness of the backlight to the scan of the liquid crystal panel. The conventional relationship between the timings to overwrite images in the liquid crystal panel and the timings to update brightness of the backlight will be explained using FIG. 4 and FIG. 5A to FIG. 5C.

FIG. 4 shows nine divided image display areas. FIG. 5A to FIG. 5C show the relationship between timings to overwrite the image in each area of FIG. 4 and timings to update brightness of the backlight. FIG. 5A shows input image signals. FIG. 5B shows timings to overwrite pixels. FIG. 5C shows timings to update brightness of the backlight. According to the method of the present invention, as shown in FIG. 5A to FIG. 5C, after one frame is scanned for a predetermined scan period, brightness of the backlight is partially updated targeting parts that have already been scanned.

### CITATION LIST

### Patent Literature

PTL 1: Japanese Patent Application Laid-Open No. HEI3-198026

### PTL 2: Japanese Patent Application Laid-Open No. 2001-142409

### PTL 3: Japanese Patent Application Laid-Open No. 2008-51905

### PTL 4: Japanese Patent Application Laid-Open No. 2008-71603

### SUMMARY

### Technical Problem

By the way, the liquid crystal display apparatus disclosed in Patent Literature 3 decides whether to correct brightness of the surrounding areas (i.e. areas other than the center area) in, for example, FIG. 1B, based on the threshold for the difference in brightness with respect to the center area. Therefore, when the difference in brightness between the center area and surrounding areas crosses the threshold, there is a possibility that brightness of the surrounding areas become discontinuous in time. Cases may occur where viewers recognize that brightness is discontinuous.

In view of the above problems, the inventors of the present invention propose a backlight apparatus that controls the light emitting state of each image display area taking into account surrounding image display areas. This backlight apparatus determines a light emission brightness value of one image display area taking into account an image of the surrounding image display areas of that image display area, and controls the light emitting state of the image display area based on the determined light emission brightness value.

FIG. 6A and FIG. 6B illustrate an overview of the method of determining a light emission brightness value by the backlight apparatus proposed by the inventors of the present invention. FIG. 6A shows nine divided image display areas. Here, in case where the light emission brightness value of, for example, the light emitting area of area E is determined, the backlight apparatus proposed by the inventors of the present invention applies weights to and takes into account information about surrounding areas A, B, C, D, F, G, H and I. FIG. 6B shows one example of applying weights. In this way, when the light emission brightness value of an area of interest is determined, the contribution by this area of interest is decreased and the contribution by the surrounding areas is increased, so that it is possible to reduce a steep difference in brightness between neighboring areas in the backlight and discontinuity in brightness values in time, and make “less deep black” less distinct.

However, in case where brightness of this backlight apparatus is updated according to, for example, the method as disclosed in Patent Literature 4, a new problem that the mismatch between an image and brightness of the backlight does not sufficiently improve, occurs. This will be explained with reference to FIG. 7A to FIG. 7C and FIG. 8A to FIG. 8C. Hereinafter, assume that time t0 to time t4 are used adequately in each figure. Time t0 is the time after all items of data in the N-th frame have been scanned. Time t1 is the time after one fourth of the N+1-th frame has been scanned. Time t2 is the time after two fourths of the N+1-th frame has been scanned. Time t3 is the time after three fourths of the N+1-th frame has been scanned. Time t4 is the time after all items of data in the N+1-th frame have been scanned.

FIG. 7A to FIG. 7C show how the state of each light emitting area transitions. FIG. 7A shows input images after all items of data in the N-th frame and the N+1-th frame are scanned. FIG. 7B shows how the light emitting state of the backlight transitions. FIG. 7C shows how the display image transitions. The backlight has divided areas of four rows and six columns.

FIG. 8A to FIG. 8C show an example of transition of the input state when an N-th frame is overwritten to an N+1-th frame in FIG. 7A to FIG. 7C. Further, in FIG. 8A, the broken lines indicate areas which are overwritten at each time.

In FIG. 8B, at time 1 (after one fourth of the frame is scanned), an upper ¼ area in the backlight emits light at brightness matching the image of the N+1-th frame, and the rest of ¾ areas emits light at brightness matching the image of the N-th frame. At time t2, a next ¼ area below the area updated at time t1 emits light at brightness matching the image of the N+1-th frame. At time t3, the next ¼ area emits light at brightness matching the N+1-th frame, and, at time t4, all the light emitting areas of the backlight emit light at brightness matching the image of the N+1-th frame. That is, the backlight updates the light emitting state only for applicable light emitting areas according to the scan of an input image.

Here, in the process of scanning an input image, the states of the image and brightness of the backlight match at t1 (after one fourth of a frame is scanned) and t3 (after three fourths of a frame is scanned), and do not at t2 (after two fourths of a frame is scanned). To be more specific, although the areas indicated by R in FIG. 8B at time t2 emit brighter light than the surroundings, these areas do not match the input image at time t2 in FIG. 8A. That is, although a white rectangular object is not present in the input image at time t2, the areas that are going to become surrounding areas at next time t3 emit light in advance. If the state of such a mismatch occurs, there is a risk that the human eyes perceive that the difference in brightness looks unnatural depending on images and image quality has deteriorated.

The object is to provide a backlight apparatus and a display apparatus that allow brightness control with minimum image quality deterioration.

### Solution to Problem

To achieve the above object, the backlight apparatus has: an illuminating section that radiates illuminating light to display an image, on an optical modulating section which has a plurality of image display areas and which displays an image by modulating per image display area illuminating light, which is radiated from a back of the light modulating section, according to an image signal; a brightness determining section that determines a light emission brightness value of the illuminating section and updates a light emitting state of the illuminating section based on the determined light emission brightness value; and an update controlling section that controls a timing to update the light emitting state, and the illuminating section comprises a plurality of light emitting areas illuminating the plurality of image display areas, respectively, the brightness determining section determines a light emission brightness value of a light emitting area illuminating a first image display area, from values acquired by applying weights to first information based on an input image signal of the first image display area and second information based on an input image signal of a second image display area and the update controlling section makes the brightness determining section update each light emitting state of the plurality of light emitting areas a plurality of times while all image display areas of the optical modulating section are scanned once according to the input image signal.

Further, the display apparatus has: the above backlight apparatus; the optical modulating section; an image signal correcting section that corrects an image signal inputted to the optical modulating section, based on the light emission brightness value determined in the brightness determining section; and a delay section that delays the image signal outputted from the image signal correcting section, by a predetermined period.

### Advantageous Effects

According to the present invention, it is possible to provide a backlight apparatus and display apparatus that allow more optimal brightness correction upon correction of brightness of the backlight apparatus according to images, and, moreover, provide a backlight apparatus and display apparatus that reduce the mismatch between an image and brightness of the backlight and allow brightness control with minimum image quality deterioration.

### BRIEF DESCRIPTION OF DRAWINGS

FIG. 1A to FIG. 1C illustrate the state of “less deep black” in still images;

FIG. 2A to FIG. 2C illustrate the state of “less deep black” in moving images;

FIG. 3A to FIG. 3C illustrate the mismatch between an image and brightness of a backlight;

FIG. 4 shows image display areas in the backlight;

FIG. 5A to FIG. 5C illustrate the relationship between timings to overwrite images and timings to update brightness of the backlight according to conventional art;

FIG. 6A and FIG. 6B illustrate an overview of the method of determining light emission brightness values by the backlight apparatus proposed by the inventors of the present invention;

FIG. 7A to FIG. 7C show how the state of each light emitting area transitions;

FIG. 8A to FIG. 8C show an example of state transition when an N-th frame is overwritten to an N+1-th frame;

FIG. 9 is a configuration diagram showing an overall configuration of a liquid crystal display apparatus according to Embodiment 1 of the present invention;

FIG. 10A and FIG. 10B are configuration diagrams showing configurations of a light emitting section and liquid crystal panel according to Embodiment 1;

FIG. 11 is a configuration diagram showing a configuration of a brightness determining section according to Embodiment 1;

FIG. 12A to FIG. 12C show examples of the characteristics of conversion tables for converting feature values into reference brightness values according to Embodiment 1;

FIG. 13 is a configuration diagram showing a configuration of a weighting section according to Embodiment 1;

FIG. 14 illustrates the concept of applying weights according to Embodiment 1;

FIG. 15A to FIG. 15C show the relationship between timings of update timing pulses and input image signals according to Embodiment 1;

FIG. 16 shows an example of an image inputted to the liquid crystal panel according to Embodiment 1;

FIG. 17 shows the reference brightness value of each light emitting area in a light emitting section which is calculated in a brightness calculating section according to Embodiment 1;

FIG. 18 shows the state of light emission when a weighting section is not used according to Embodiment 1;

FIG. 19 shows an image that is actually displayed on a liquid crystal panel according to Embodiment 1;

FIG. 20 shows weighted brightness values outputted from a weighting section according to Embodiment 1;

FIG. 21 illustrates calculation of light emission brightness values according to Embodiment 1;

FIG. 22 shows the state of light emission when the weighting section is used according to Embodiment 1;

FIG. 23 shows an image that is actually displayed on the liquid crystal panel according to Embodiment 1;

FIG. 24 shows an input state of an image signal at each time according to Embodiment 1;

FIG. 25A and FIG. 25B are the first views showing how the state of each image display area transitions according to Embodiment 1;

FIG. 26A to FIG. 26D are the second views showing how the state of each image display area transitions according to Embodiment 1;

FIG. 27A to FIG. 27C illustrate an aspect in case where average brightness values are used as feature values according to Embodiment 1;

FIG. 28A to FIG. 28C illustrate an aspect in case where peak brightness values are used as feature values according to Embodiment 1;

FIG. 29 illustrates another method of updating light emitting states according to Embodiment 1;

FIG. 30 illustrates weights in case of M:N=2:1 according to Embodiment 1;

FIG. 31 illustrates weights in case of M:N=1:2 according to Embodiment 1;

FIG. 32 illustrates a case of decreasing weights applied to reference brightness values of light emitting areas located diagonally according to Embodiment 1;

FIG. 33 illustrates a case of applying weights to reference brightness values of light emitting areas of five rows and five columns according to Embodiment 1;

FIG. 34 is a configuration diagram showing a configuration of a brightness determining section according to Embodiment 2;

FIG. 35 is a configuration diagram showing an example of a configuration of a weighting section according to Embodiment 2;

FIG. 36 is a configuration diagram showing another configuration example of a weighting section according to Embodiment 2;

FIG. 37 is a configuration diagram showing the overall configuration of a liquid crystal display apparatus according to Embodiment 3;

FIG. 38A to FIG. 38C illustrate the relationship between the scan of a liquid crystal panel and timings to update light emitting states; and

FIG. 39 illustrates an advantage of updating the light emitting states while image display areas are scanned according to Embodiment 3.

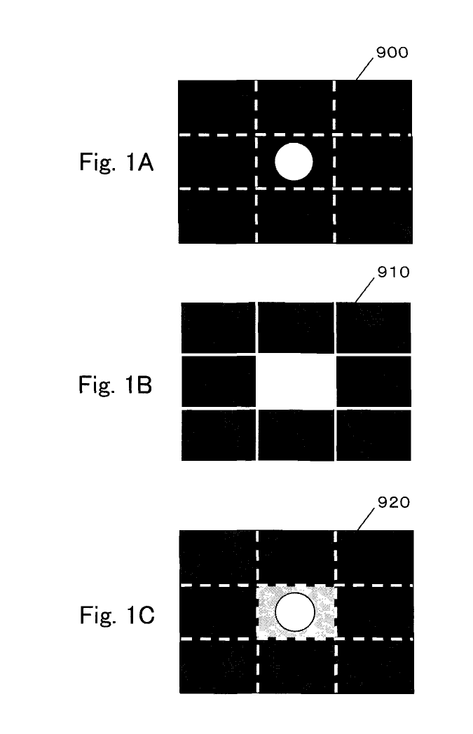

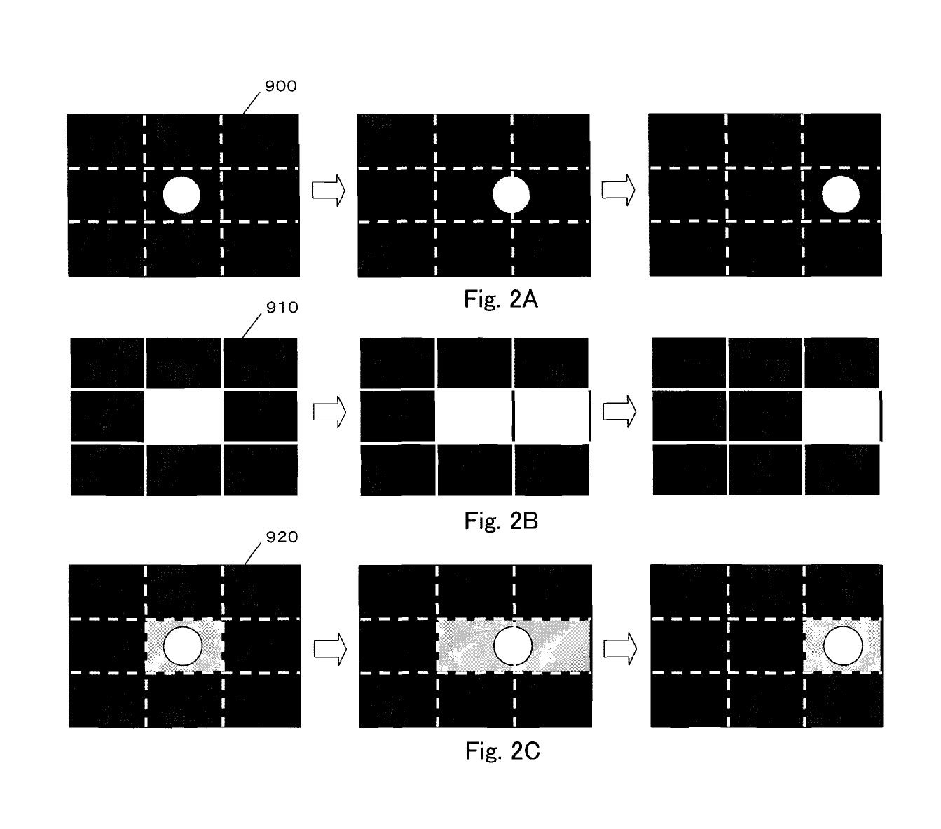

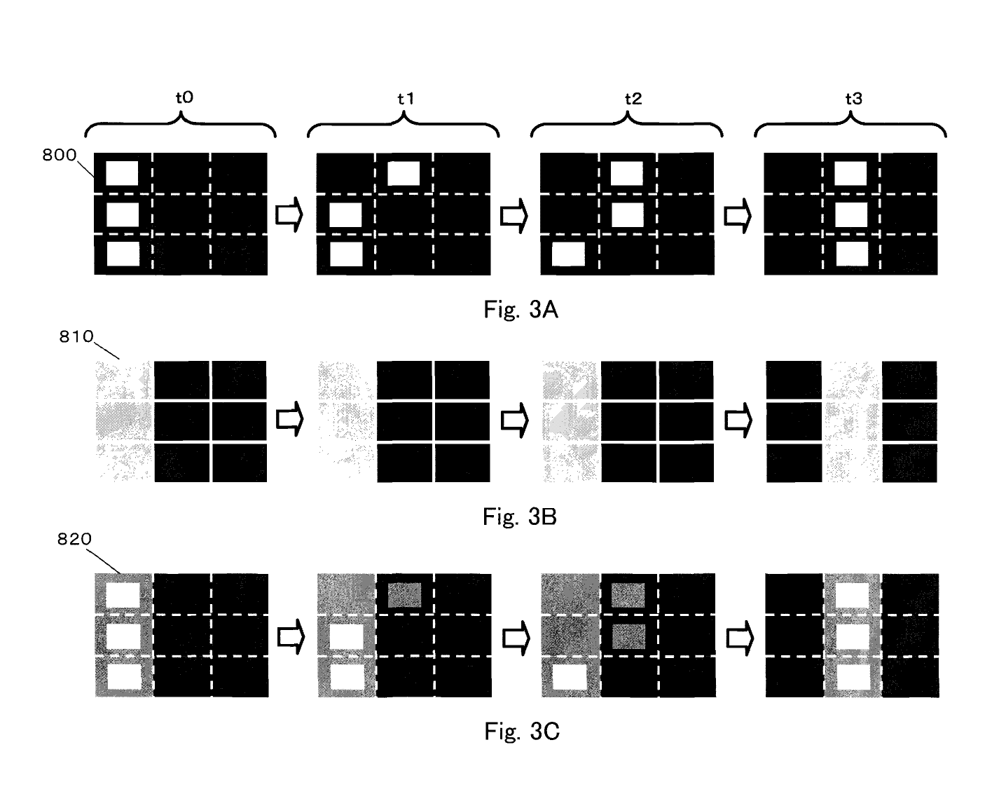

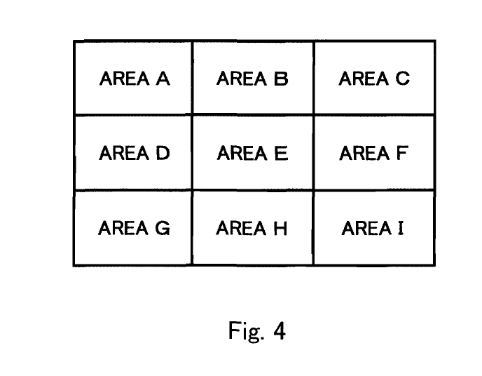

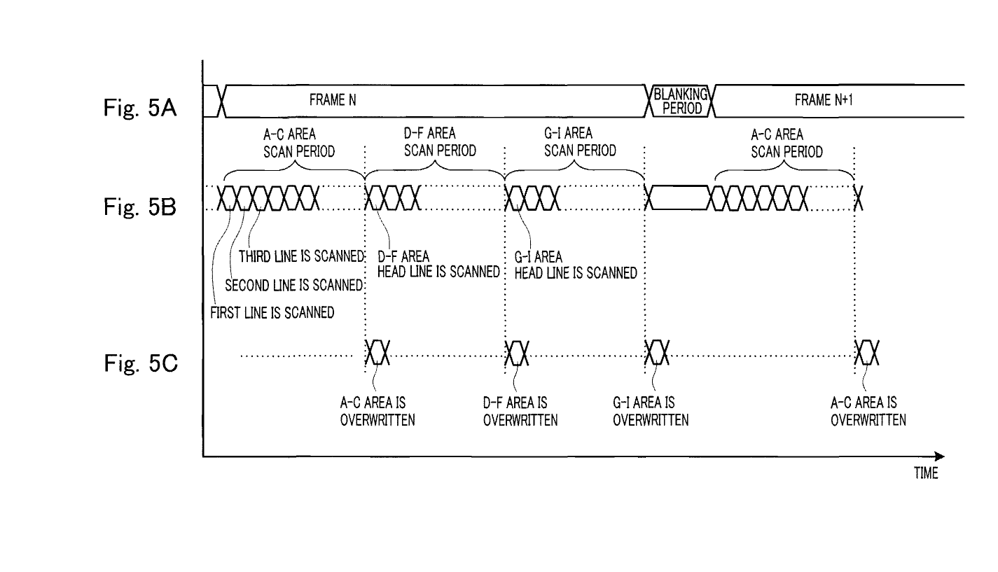

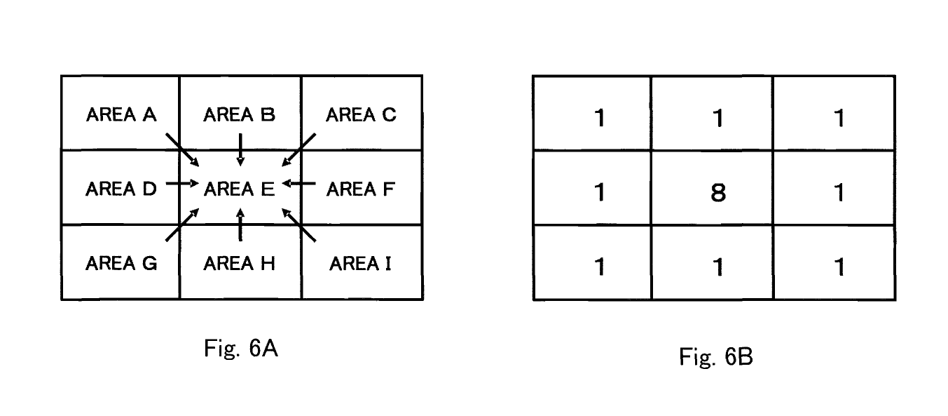

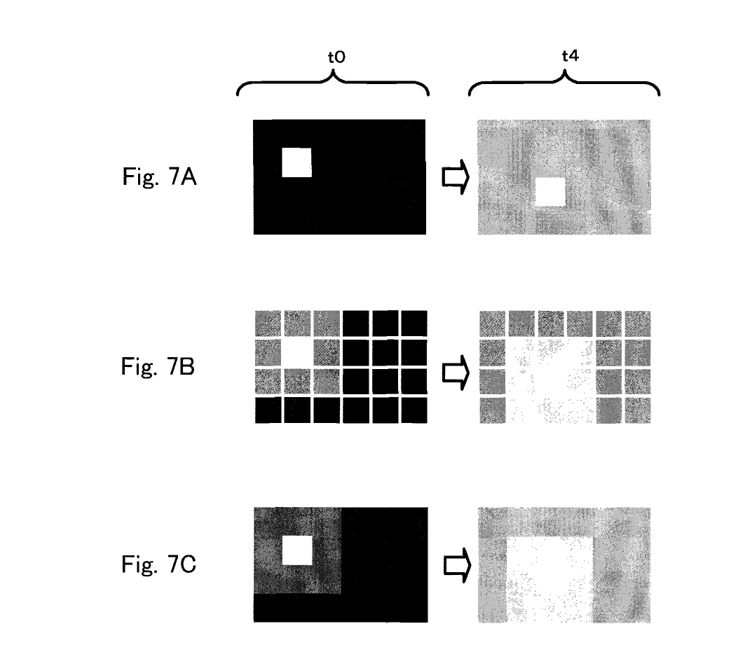

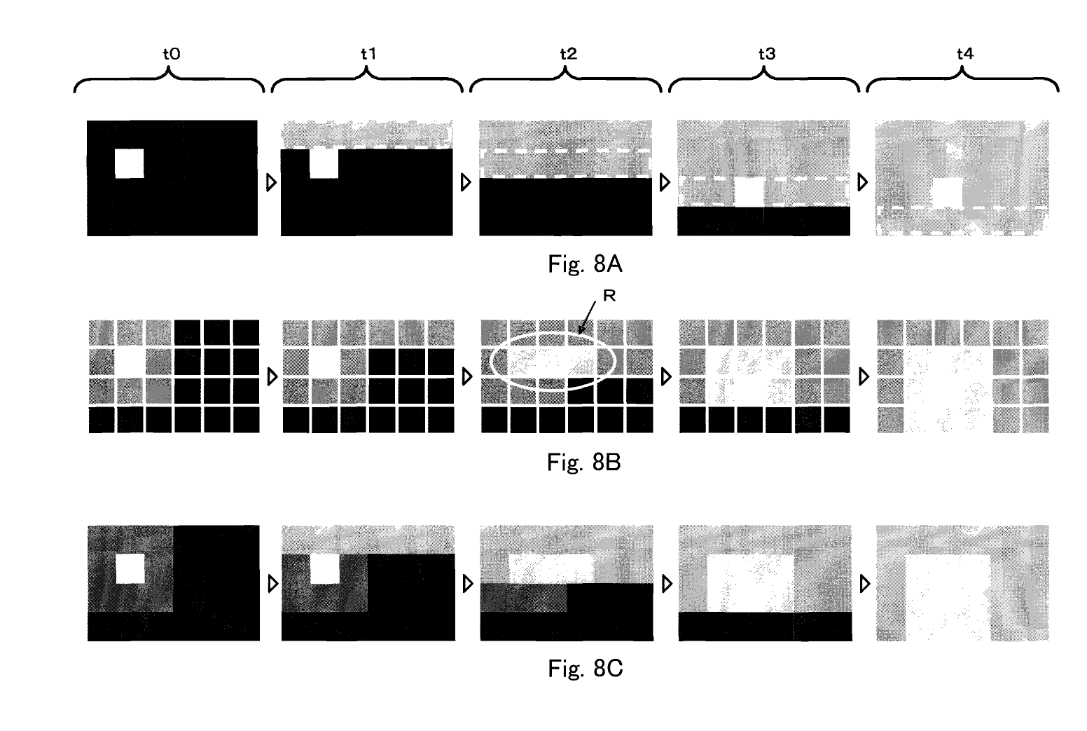

### DESCRIPTION OF EMBODIMENTS

### Embodiment 1

Hereinafter, Embodiment 1 (an embodiment of applying weights to reference brightness values), which is an example where the present invention is applied to a liquid crystal display apparatus, will be explained with reference to the accompanying drawings.

<1-1. Configuration of Liquid Crystal Display Apparatus>

First, the configuration of the liquid crystal display apparatus will be explained.

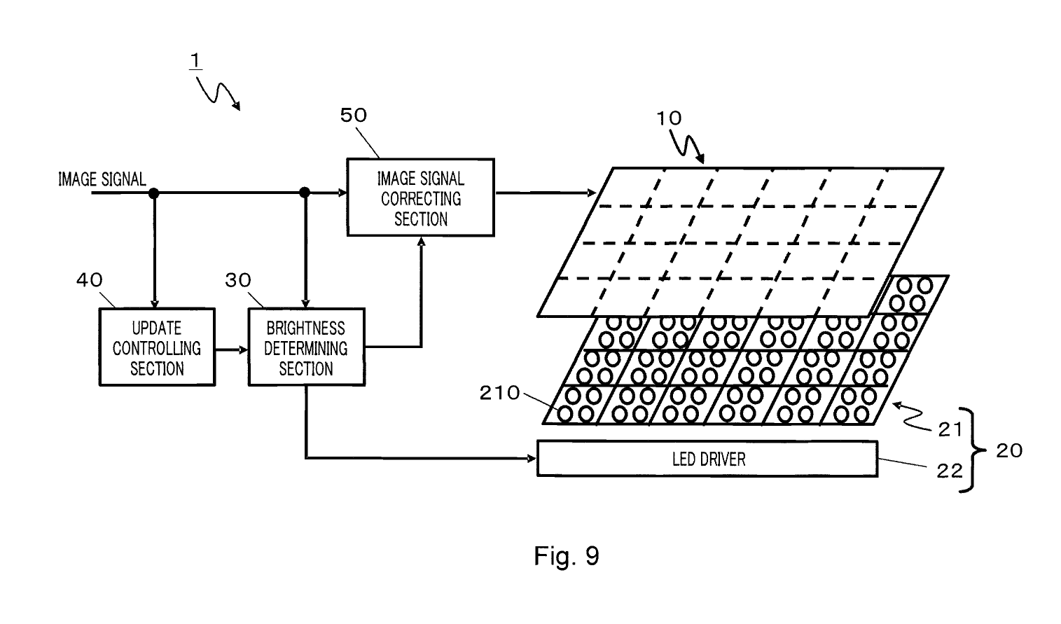

FIG. 9 is a configuration diagram showing the overall configuration of the liquid crystal display apparatus. Roughly, liquid crystal display apparatus 1 has liquid crystal panel 10, illuminating section 20, brightness determining section 30, update controlling section 40 and image signal correcting section 50. Hereinafter, illuminating section 20, brightness determining section 30 and update controlling section 40 will be collectively referred to as “backlight.” The configuration of each section will be explained below in detail.

<1-1-1. Liquid Crystal Panel>

Liquid crystal panel 10 modulates illuminating light that is radiated from its back, according to an image signal, and displays an image.

Liquid crystal panel 10 has a total of 24 image display areas of four rows and six columns as indicated by broken lines in the figure. Each row has six image display areas. Each image display area has a plurality of pixels.

Liquid crystal panel 10 is formed by providing a liquid crystal layer divided per pixel, in a glass substrate. In liquid crystal panel 10, a signal voltage is applied to the liquid crystal layer matching each pixel by the gate driver (not shown), source driver (not shown) and so forth, and the aperture ratio is controlled per pixel. Liquid crystal panel 10 uses the IPS (In Plane Switching) scheme. The IPS scheme is a scheme functioning in a simple manner where liquid crystal molecules rotate in parallel with the glass substrate. Consequently, the liquid crystal panel that employs the IPS scheme provides a wide view angle, and has characteristics that change little in color hue depending on directions to be seen and change little in color hue in the full tonal gradation.

Liquid crystal panel 10 is an example of the optical modulating section. Other schemes such as the VA (Vertical Alignment) scheme may be employed as the scheme for the liquid crystal panel.

<1-1-2. Illuminating Section>

Illuminating section 20 radiates illuminating light on liquid crystal panel 10 from the back of liquid crystal panel 10, so that liquid crystal panel 10 displays an image.

Illuminating section 20 has light emitting section 21 formed with a plurality of light emitting areas. Each light emitting area is provided to face each image display area of liquid crystal panel 10 and mainly illuminates the facing image display area. Here, the word “mainly” suggests that each light emitting area may radiate part of its illuminating light on other image display areas that the light emitting area does not face. Each light emitting area has four LEDs 210 as the light sources. Further, illuminating section 20 has LED driver 22 for driving LEDs 210 of light emitting section 21.

LED driver 22 has 24 driving circuits corresponding to the total number of light emitting areas, so that it is possible to drive each light emitting area independently.

With the above configuration, illuminating section 20 allows brightness control per light emitting area.

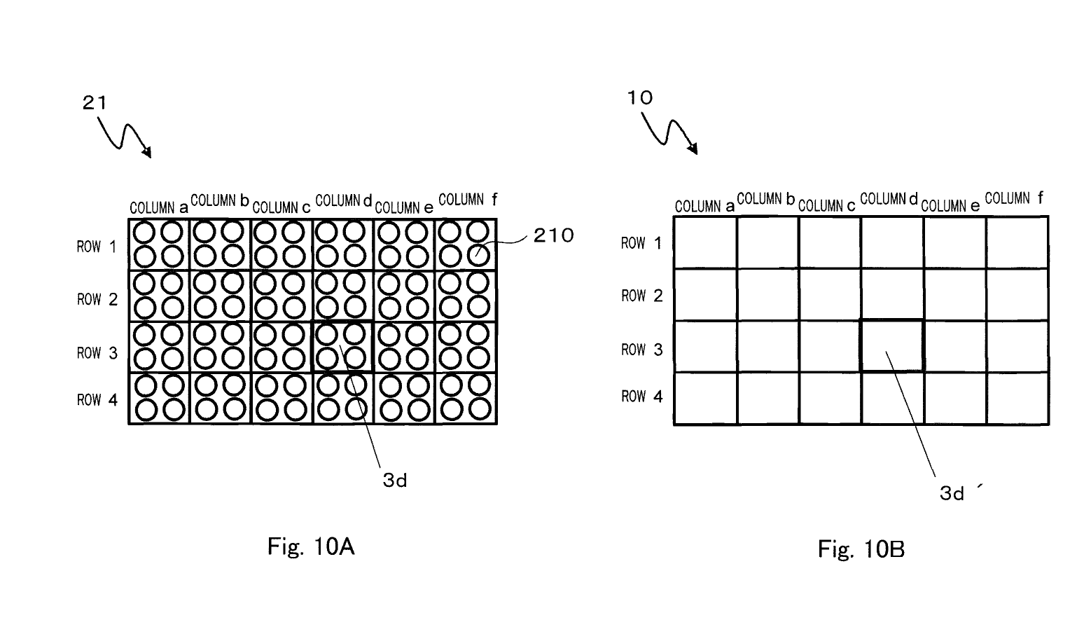

FIG. 10A and FIG. 10B are configuration diagrams showing the configurations of light emitting section 21 and liquid crystal panel 10. Light emitting section 21 has a total of 24 light emitting areas of four rows and six columns. Here, each light emitting area is specified by the combination of an Arabic reference numeral corresponding to the row number and an alphabetical reference numeral corresponding to the column number.

For example, in FIG. 10A, the light emitting area corresponding to row number 3 and column number d is referred to as “light emitting area 3d.” FIG. 10B is a configuration diagram showing the configuration of liquid crystal panel 10. Each image display area is represented by the combination of the row number and the column number, similar to the light emitting areas of light emitting section 21 in FIG. 10A. Further, an image display area is represented by assigning “′” to its reference numeral to distinguish from a light emitting area. That is, the image display area corresponding to row number 3 and column number d is referred to as “image display area 3d′.” For example, light emitting area 3d mainly illuminates image display area 3d′.

LED 210 emits white light. Four LEDs 210 belonging to one light emitting area are connected to one driving circuit of LED driver 22. Further, four LEDs 210 belonging to one light emitting area emit light at the same brightness, according to signals from LED driver 22.

Further, LED 210 is not limited to LEDs that emit white light directly. LED 210 may emit white light by blending, for example, light of three colors of red, green and blue. Further, the number of LEDs 210 belonging to one light emitting area is not limited to four. More LEDs or fewer LEDs may be used.

<1-1-3. Brightness Determining Section>

Brightness determining section 30 determines the light emission brightness value of each of a plurality of light emitting areas included in illuminating section 20, based on the input image signal. The input image signal is formed by arranging in a time sequence an image signal of each of a plurality of image display areas included in liquid crystal panel 10. That is, brightness determining section 30 receives as input an input image signal of each image display area of liquid crystal panel 10, and outputs the light emission brightness value of each light emitting area, to LED driver 22 of illuminating section 20. Further, brightness determining section 30 outputs the light emission brightness value of each light emitting area to image signal correcting section 50.

Particularly, the characteristics of liquid crystal display apparatus 1 of the present invention include that brightness determining section 30 determines the light emission brightness value of each light emitting area, from the values acquired by applying weights to information based on the input image signal of the first image display area (i.e. first information) and information based on the input image signal of second image display areas (i.e. second information). The first image display area refers to an image display area that a light emitting area for which the light emission brightness value is determined illuminates mainly. A second image display area refers to a different image display area from the image display area that a light emitting area for which the light emission brightness value is determined illuminates mainly.

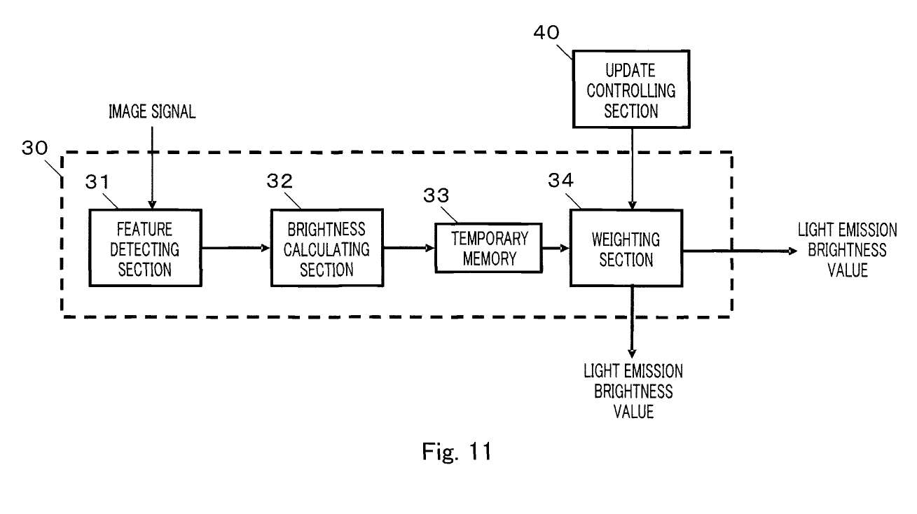

FIG. 11 is a configuration diagram showing a specific configuration of brightness determining section 30. Roughly, brightness determining section 30 has feature detecting section 31, brightness calculating section 32, temporary memory 33 and weighting section 34.

<1-1-3-1. Feature Detecting Section>

Feature detecting section 31 detects the feature value of an input image signal per image display area. Hereinafter, a “feature value” refers to a value used directly to calculate a reference brightness value (described later). Here, an average value of brightness signals of individual pixels (hereinafter “average brightness value”) will be used as a feature value. The brightness signal of each pixel is included in an input image signal. That is, feature detecting section 31 receives as input an image signal, and detects the average brightness value per image display area. Then, feature detecting section 31 outputs the detected feature value sequentially to brightness calculating section 32.

<1-1-3-2. Brightness Calculating Section>

Brightness calculating section 32 calculates the reference brightness value of each light emitting area, based on the input feature value. To be more specific, using conversion tables, brightness calculating section 32 converts the average brightness value into a reference brightness value on a per image display area basis, and outputs the reference brightness value to temporary memory 33. A “reference brightness value” refers to a value which serves as a reference when the brightness value (hereinafter “light emission brightness value”) to apply to a light emitting area of interest is calculated.

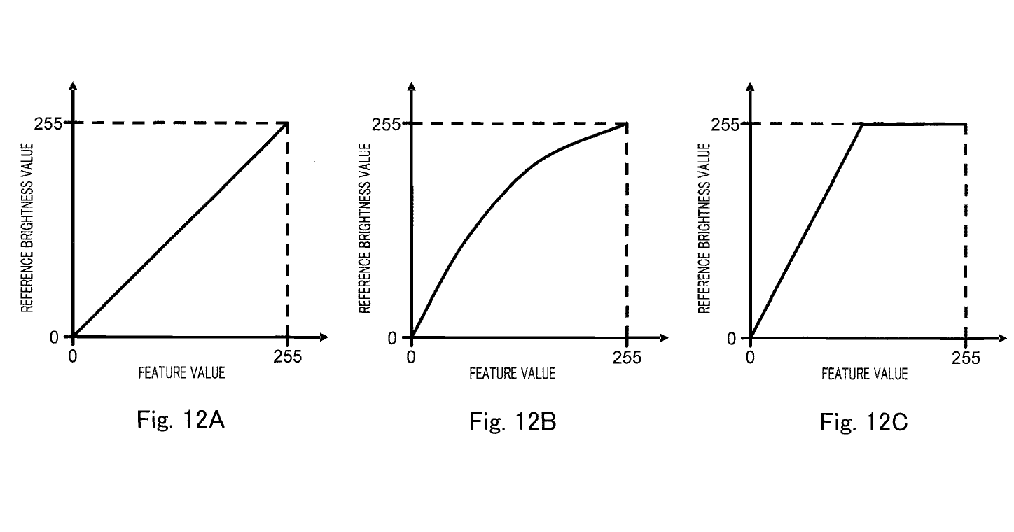

FIG. 12A to FIG. 12C show examples of the characteristics of conversion tables for converting the feature value into a reference brightness value. In FIG. 12A to FIG. 12C, the horizontal axis represents the feature value, and the vertical axis represents the reference brightness value.

For example, in case where a conversion table having the characteristics shown in FIG. 12A is used, the feature value is converted into the same value as the reference brightness value. For example, if the feature value is 0, the reference brightness value is 0 and, if the feature value is 255, the reference brightness is 255. Further, in case where, for example, the γ curve of the feature value is corrected, it is equally possible to use a conversion table having the characteristics shown in FIG. 12B. Furthermore, in case where the reference brightness value is saturated at a predetermined feature value or more, it is equally possible to use a conversion table having the characteristics shown in FIG. 12C. By using these conversion tables, brightness calculating section 32 can adjust the light emission brightness of light emitting section 21 for an input image signal.

For example, in case where the feature value is the average brightness value, the feature value becomes small in an image in which there is a very small white light spot on a black background. Therefore, cases occur where brightness of the white light spot becomes too low. In this case, a conversion table having the characteristics shown in FIG. 12C makes brightness of the white light spot look better than a conversion table having the characteristics shown in FIG. 12A. This is because, with the characteristics shown in FIG. 12C, a comparatively high reference brightness value corresponds to a small feature value.

Accordingly, it is preferable that brightness calculating section 32 provides a plurality of conversion tables of different characteristics in advance, and switches between these conversion tables to use, according to the state of the image so as to acquire better image quality. In this way, brightness calculating section 32 can adaptively switch a conversion table to use to calculate the reference brightness value according to an image.

Further, although a case has been explained with the present embodiment where conversion tables are used, the present invention is not limited to this. For example, using conversion functions having the above-described conversion characteristics, brightness calculating section 32 may convert feature values into reference brightness values when necessary. According to this configuration, it is possible to reduce the amount of the memory.

<1-1-3-3. Temporary Memory>

Temporary memory 33 stores the reference brightness values outputted from brightness calculating section 32. That is, temporary memory 33 sequentially stores the reference brightness value on a per light emitting area basis, and stores the reference brightness values of all light emitting areas on a temporary basis. Temporary memory 33 is one example of the storing section.

<1-1-3-4. Weighting Section>

Weighting section 34 determines the light emission brightness value of the first light emitting area, from the values acquired by applying weights to the reference brightness value of the first light emitting area, which is the first information, and the reference brightness values of the second light emitting areas, which are the second information. That is, to determine the light emission brightness value of each light emitting area (i.e. the first light emitting area), weighting section 34 retrieves the reference brightness value (i.e. first information) for this one light emitting area stored in temporary memory 33. Further, weighting section 34 also retrieves from temporary memory 33 the reference brightness values (i.e. second information) of predetermined light emitting areas (i.e. second light emitting areas) different from that one light emitting area. Then, weighting section 34 applies weights to a plurality of retrieved reference brightness values, adds a plurality of values after weights are applied (hereinafter “weighted brightness values”) and determines the final light emission brightness value of that light emitting area (i.e. the first light emitting area).

With the present embodiment, “second light emitting areas” refer to the eight neighboring light emitting areas surrounding the first light emitting area. For example, to illustrate using FIG. 10A, in case where the first light emitting area is light emitting area 3d, the second light emitting areas are light emitting areas 2c, 2d, 2e, 3c, 3e, 4c, 4d and 4e.

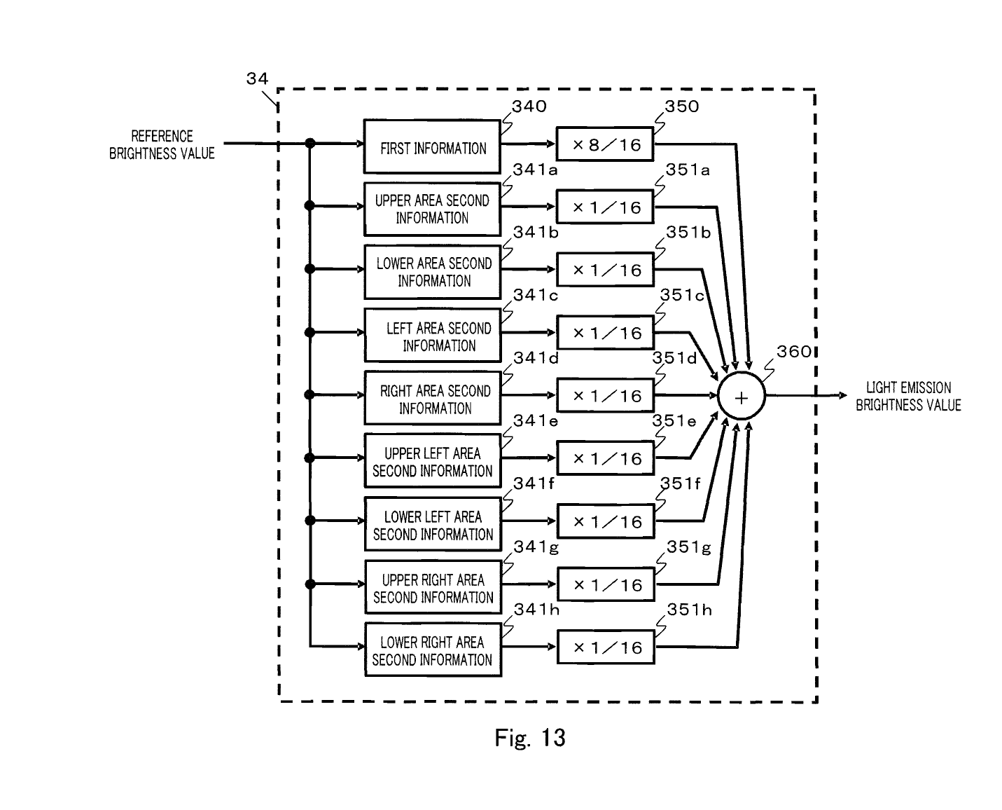

FIG. 13 is a configuration diagram showing a more specific configuration of weighting section 34 according to the present embodiment. Weighting section 34 has: first information retrieving block 340; eight second information retrieving blocks 341a, 341b, 341c, 341d, 341e, 341f, 341g and 341h; first information weighting block 350; eight second information weighting blocks 351a, 351b, 351c, 351d, 351e, 351f, 351g and 351h; and adding block 360.

First information retrieving block 340 retrieves the first information from temporary memory 33. First information weighting block 350 applies a weight to the first information retrieved by first information retrieving block 340, and outputs the first weighted brightness value.

Second information retrieving blocks 341a to 341h retrieve the second information of second light emitting areas 2c to 4e from temporary memory 33. Second information weighting blocks 351a to 351h each apply a weight to the second information retrieved from second information retrieving blocks 341a to 341h, and output the second weighted brightness values.

Adding block 360 adds the first weighted brightness value outputted from first information weighting block 350 and the eight second weighted brightness values outputted from second information weighting blocks 351a to 351h.

With the present embodiment, first information weighting block 350 applies an 8/16 weight to the first information. Further, second information weighting blocks 351a to 351h each apply a 1/16 weight equally to all items of the second information. The second information is the reference brightness value of each one of the eight neighboring light emitting areas surrounding the first light emitting area. Hereinafter, the weight applied to the first information (i.e. the reference brightness value of the first light emitting area) is referred to as the “first weight,” and the weights applied to the second information (i.e. the reference brightness values of the second light emitting areas) are referred to as “second weights.”

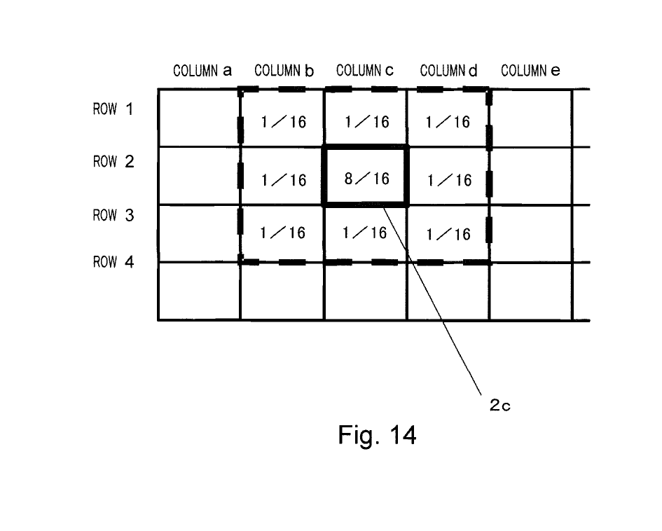

FIG. 14 illustrates the concept of applying weights. FIG. 14 shows part of light emitting section 21 where how a weight is applied to the reference brightness value of each light emitting area is shown in case where the first light emitting area is light emitting area 2c. In this case, the light emitting areas belonging to the surrounding areas of three rows and three columns around light emitting area 2c become the second light emitting areas (i.e. the areas surrounded by broken lines). Here, a case will be explained where the first weight occupies the 8/16 weight and the second weights each occupy the 1/16 weight.

As shown in FIG. 14, in light emitting area 2c, the 8/16 weight is applied to the reference brightness value. Further, in the surrounding second light emitting areas, the 1/16 weight is applied to each reference brightness value. The weights are applied in this way, and therefore the sum of the weights is one, and the ratio of the weight applied to the reference brightness value of the first light emitting area (i.e. first weight) and the total value of the weights applied to the reference brightness values of all the second light emitting areas (i.e. the total value of second weights) is 1:1. That is, the first weight occupies 50 percent and the total value of the second weights occupies 50 percent (that is, each second weight occupies 50/8=6.25 percent), which makes the total of the weights 100 percent.

By adding the nine weighted brightness values obtained by applying weights, the final light emission brightness value of light emitting area 2c is calculated.

Here, an example of a method of determining a predetermined ratio of a numerical value of a weight for each light emitting area without changing the sum of the weights will be explained.

First, assume that the ratio of the first weight and the total value of the second weights is set to M:N. Further, the number of the second light emitting areas is X.

In this condition, the first weight is determined by M×X/{(M+N)×X}.

Further, the total value of the second weights can be determined by N×X/{(M+N)×X}. Here, in case where all of the second weights are made the same value, the second weight is determined by N/{(M+N)×X}.

With the present embodiment, M:N=1:1 and X=8 hold. Consequently, the first weight and each second weight can be determined as the 8/16 weight and 1/16 weight, respectively.

Note that the method of setting weights is not limited to this in particular and another method is also possible.

With this configuration, when light emission brightness values of light emitting areas are calculated, it is possible to calculate a light emission brightness value reflecting brightness signals of surrounding light emitting areas of that light emitting area.

The determined light emission brightness values of light emitting areas are outputted to LED driver 22 of illuminating section 20 and image signal correcting section 50.

<1-1-4. Update Controlling Section>

Update controlling section 40 controls the timings to transmit light emission brightness values (hereinafter “update timings”) in the form of data to LED driver 22. A light emission brightness value refers to a brightness value of each light emitting area that is determined and outputted by brightness determining section 30. That is, an update timing refers to a timing to update the light emitting state of illuminating section 20 based on the light emission brightness values determined in brightness determining section 30. To be more specific, update controlling section 40 controls update timings by generating update timing pulses for brightness determining section 30. Here, the timings to generate update timing pulses will be explained.

In liquid crystal panel 10 shown in FIG. 10B, an input image signal is scanned in order of image display areas 1a′ to 1f′, image display areas 2a′ to 2f′, image display areas 3a′ to 3f′ and image display areas 4a′ to 4f′.

Update controlling section 40 generates an update timing pulse such that weighting section 34 transmits light emission brightness values of all light emitting areas to illuminating section 20. To be more specific, in synchronization with the timing at which the scan of an input image signal in image display areas 1a′ to 1f′ is finished, update controlling section 40 generates an update timing pulse such that light emission brightness values of all light emitting areas are transmitted. Image display areas 1a′ to 1f′ form one row in the image display area. In other words, image display areas 1a′ to 1f′ belong to the same row. Similarly, update controlling section 40 generates update timing pulses in synchronization with the timing at which the scan of an input image signal in image display areas 2a′ to 2f′ is finished, the timing at which the scan of an input image signal in image display areas 3a′˜3f′ is finished and the timing at which the scan of an input image signal in image display areas 4a′ to 4f′ is finished.

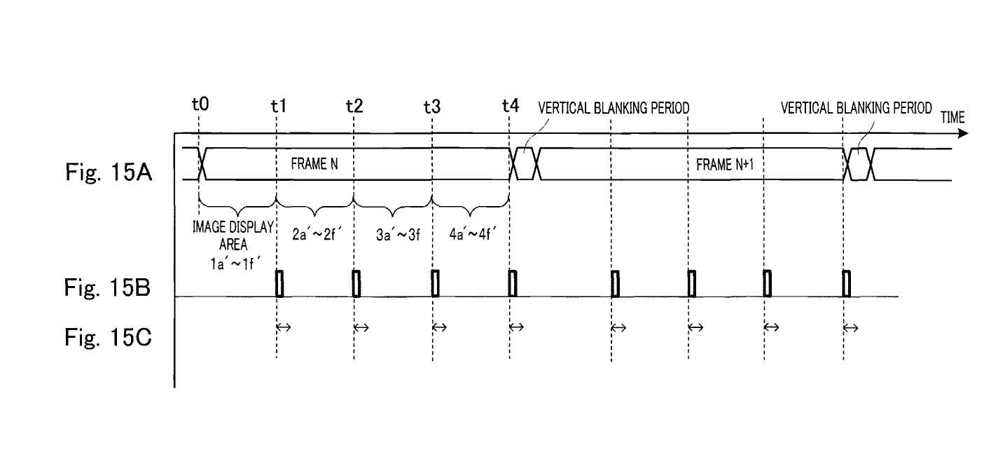

FIG. 15A to FIG. 15C show the relationship between the timings for update timing pulses generated in update controlling section 40 and input image signals. FIG. 15A shows input image signals received as input in liquid crystal panel 10. FIG. 15B shows update timing pulses generated in update controlling section 40. FIG. 15C shows calculation of and update timings for light emission brightness.

As shown in FIG. 15B, update timing pulses are generated at the timing at which the scan of image display areas 1a′ to 1f′ is finished, at the timing at which the scan of image display areas 2a′ to 2f′ is finished, at the timing at which the scan of image display areas 3a′ to 3f′ is finished and at the timing at which the scan of image display areas 4a′ to 4f′ is finished. At the timing after each update timing pulse has been generated, the reference brightness value of each light emitting area stored in temporary memory 33 is retrieved. The retrieved reference brightness value is inputted to weighting section 34. As a result, the light emission brightness values of all light emitting areas are calculated and transmitted to LED driver 22. Therefore, the light emitting states of all light emitting areas of light emitting section 21 are simultaneously updated four times in one frame period of an input image signal.

<1-1-5. Image Signal Correcting Section>

Image signal correcting section 50 corrects an image signal inputted to liquid crystal panel 10, based on the light emission brightness values determined in brightness determining section 30.

When brightness control is performed on a per light emitting area basis, even if an image display area receives the same original image signal, the image display area varies brightness of the image to be displayed, depending on the case where the light emission brightness value of that light emitting area is determined low and the case where the light emission brightness value of that light emitting area is determined high. Therefore, cases occur where a display image looks unnatural. In order to decrease this unnaturalness, in association with the light emission brightness value of each light emitting area, image signal correcting section 50 corrects an image signal of an image to be displayed. To be more specific, image signal correcting section 50 changes a contrast gain of an image to be displayed on liquid crystal panel 10 according to the degree of change in each light emission brightness value. By this means, image signal correcting section 50 corrects the negative effect accompanying the above-described brightness control per light emitting area.

The configuration of the liquid crystal display apparatus has been explained so far.

<1-2. Operation of Liquid Crystal Display Apparatus>

Next, as to a specific example of the display operation by the liquid crystal display apparatus based on the above configuration, the characteristic operation of the present invention will be mainly explained.

<1-2-1. Calculation of Reference Brightness Values>

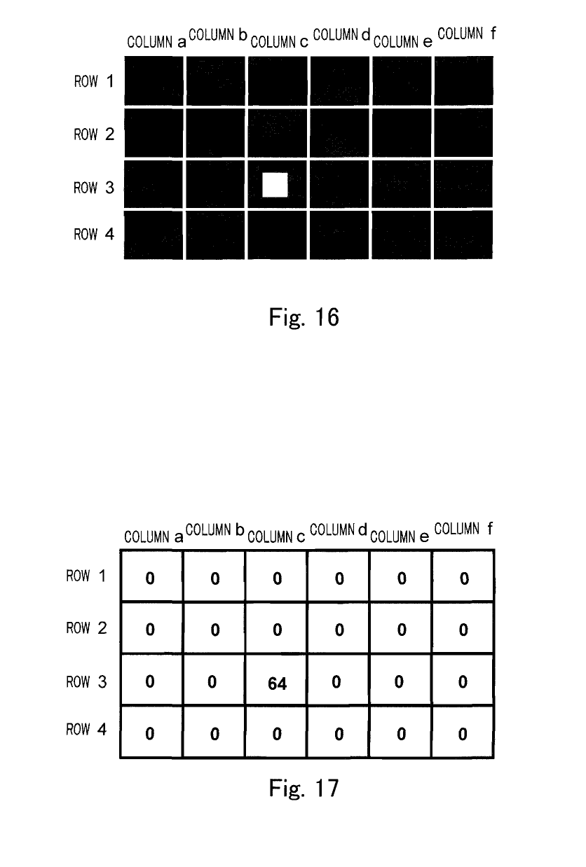

FIG. 16 shows an example of an image inputted to liquid crystal panel 10 where a 100 percent white rectangular object is placed on a black background. Note that, in FIG. 16, the white grid lines indicate the frames of image display areas of liquid crystal panel 10 (or corresponding light emitting areas of light emitting section 21) and are not included in the actual image.

The image signal of the image shown in FIG. 16 is inputted to feature detecting section 31 in brightness determining section 30, and its average brightness value, which is the feature value, is detected per image display area. Then, each detected feature value is inputted to brightness calculating section 32 and is converted into the reference brightness value of each light emitting area.

FIG. 17 shows the reference brightness value of each light emitting area of light emitting section 21 which is calculated in brightness calculating section 32. Note that brightness calculating section 32 used here has the conversion table having the characteristics shown in FIG. 12A. Consequently, the feature value is converted into a value of the same value as the reference brightness value, and, for example, if the feature value is 0, the reference brightness value is 0, if the feature value is 128, the reference brightness value is 128 and, if the feature value is 255, the reference brightness value is 255.

The numerical values in FIG. 17 will be explained in details using light emitting area 3c as an example. In case of light emitting area 3c, the rectangular object in FIG. 16 is an image of 100 percent white. Therefore, the brightness signal of each pixel included in an image signal showing the object portion has a maximum value of 255. The rectangular object in FIG. 16 occupies the ¼ area of the image display area associated with light emitting area 3c. That is, in one fourth of the pixels of the corresponding image display area, the brightness signal takes the maximum value of 255. Therefore, an average brightness value of 64 is detected for light emitting area 3c as a feature value, and a reference brightness value of 64 is determined.

<1-2-2. Calculation of Light Emission Brightness Values by Applying Weights>

Next, the operation of weighting section 34 with respect to calculated reference brightness values will be explained.

Here, to clarify the function of the present invention, the case where weighting section 34 is not used will be explained first for comparison.

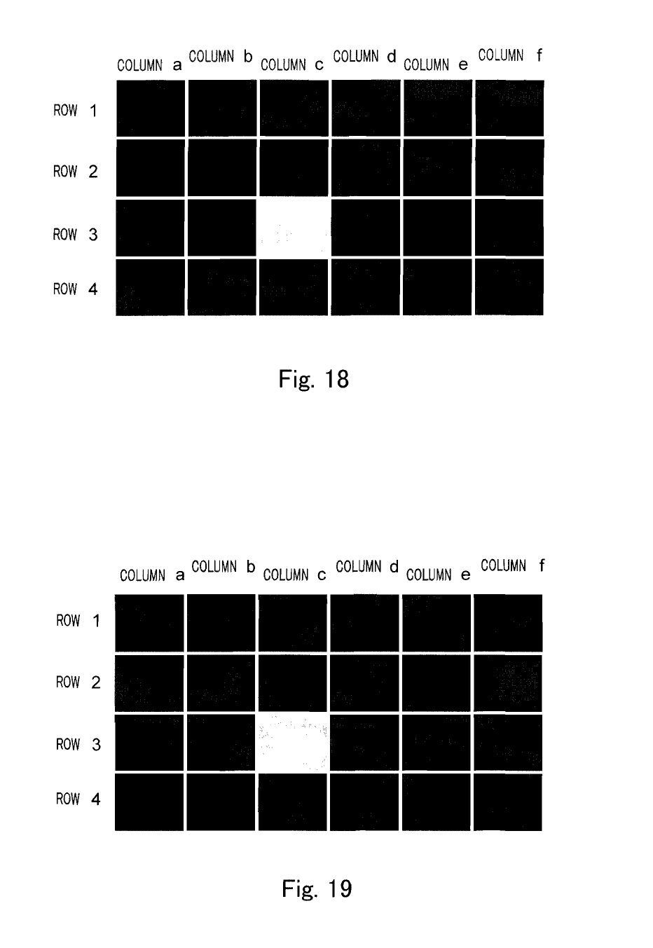

FIG. 18 shows the light emitting state of light emitting section 21 in case where the reference brightness values shown in FIG. 17 are inputted to illuminating section 20 as is without passing through weighting section 34. Further, FIG. 19 shows an image that is actually displayed on liquid crystal panel 10 when light in FIG. 18 illuminates liquid crystal panel 10 from its back.

As shown in FIG. 19, upon comparison of a light emitting area (for example, light emitting area 2c) that is not emitting light and light emitting area 3c that is emitting light, the black part in image display area 3c′ associated with light emitting area 3c becomes bright and less deep. That is, image display area 3c′ shows an undesirable display in which “less deep black” is seen. This results from the difference between light emission brightness values of light emitting areas that are not emitting light and light emitting areas that are emitting light.

Next, a case where weighting section 34 is used will be explained.

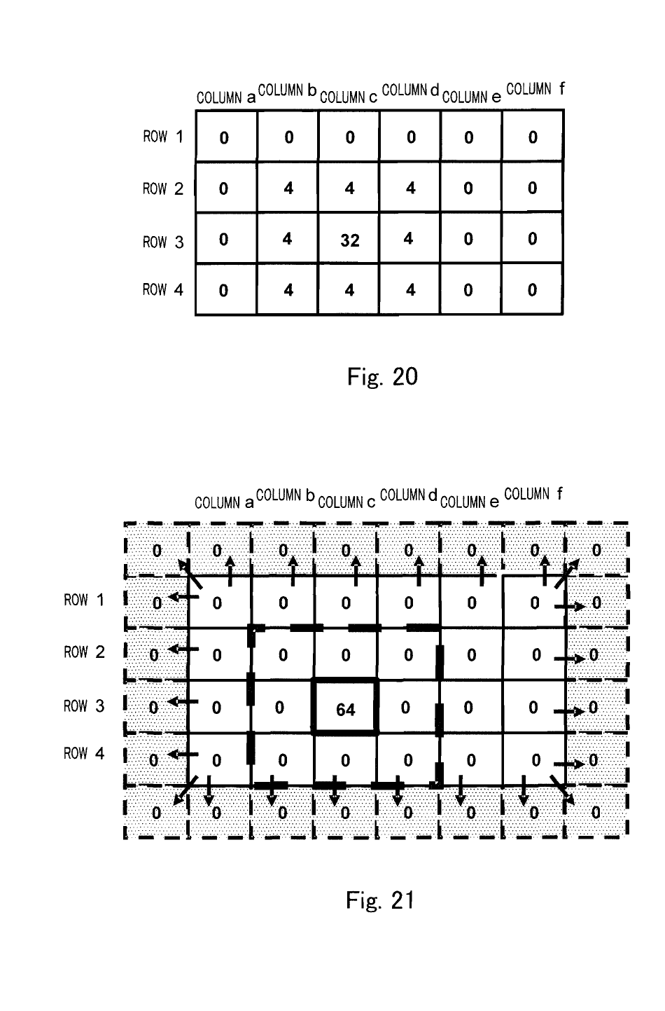

FIG. 20 shows weighted brightness values outputted from weighting section 34. The calculation of numerical values in FIG. 20 will be explained in details using FIG. 21.

FIG. 21 illustrates calculation of numerical values of reference brightness values before the reference brightness values are inputted to weighting section 34. For example, in case of light emitting area 3c, the reference brightness value corresponding to the first information is 64 as shown in FIG. 21. The second information of light emitting area 3c includes each reference brightness value of eight surrounding light emitting areas 2b, 2c, 2d, 3b, 3d, 4b, 4c and 4d.

Here, as explained in the above configuration, first information weighting block 350 applies the 8/16 weight to the first information. That is, the value of 64×( 8/16) is derived from light emitting area 3c as the first weighted brightness value.

Second information weighting blocks 351a to 351h each apply the 1/16 weight to the second information. That is, the values of 0×( 1/16) are derived from light emitting areas 2b, 2c, 2d, 3b, 3d, 4b, 4c and 4d as second weighted brightness values.

Then, a sum of 32 is calculated by adding these nine weighted brightness values, as the light emission brightness value of light emitting area 3c.

Similarly, the case of light emitting area 2b will be explained. In case of light emitting area 2b, as shown in FIG. 21, the reference brightness value corresponding to the first information is 0. The second information of light emitting area 2b is each reference brightness value of eight surrounding light emitting areas 1a, 1b, 1c, 2a, 2c, 3a, 3b and 3c.

Here, first information weighting block 350 applies the 8/16 weight to the first information. That is, the value of 0×( 8/16) is derived from light emitting area 2b as the first weighted brightness value.

Second information weighting blocks 351a to 351h each apply the 1/16 weight to the second information. That is, the values of 0×( 1/16) are derived from light emitting areas 1a, 1b, 1c, 2a, 2c, 3a and 3b as second weighted brightness values. Then, the value of 64×( 1/16) is derived from light emitting area 3c, in which the reference brightness value is 64, as the second weighted brightness value.

Then, a sum of 4 is calculated by adding these nine weighted brightness values, as the light emission brightness value of light emitting area 2b.

By calculating the light emission brightness values of all light emitting areas according to the same method, the light emission brightness values shown in FIG. 20 are acquired.

Note that there are no light emitting areas in at least one of eight directions of the light emitting areas at the end parts of light emitting section 21 (the light emitting areas belonging to row 1, row 4, column a and column f). Therefore, as shown in FIG. 21, weighting section 34 calculates the light emission brightness values of these light emitting areas at the end parts by using virtual light emitting areas that extend in the row direction and column direction to assume that there are light emitting areas in eight surrounding directions of all light emitting areas.

That is, weighting section 34 adds one row of virtual light emitting areas having the same reference brightness value as in row 1, to the upper side of row 1, and adds one row of virtual light emitting areas having the same reference brightness value as in row 4, to the lower side of row 4. Then, weighting section 34 adds one column of virtual light emitting areas having the same reference brightness value as in row a, to the left side of column a, and adds one column of virtual light emitting areas having the same reference brightness values as in column f, to the right side of column f. Further, weighting section 34 extends the light emitting areas at the four corners of light emitting section 21 to use as light emitting areas corresponding to the four corners of the extended virtual area.

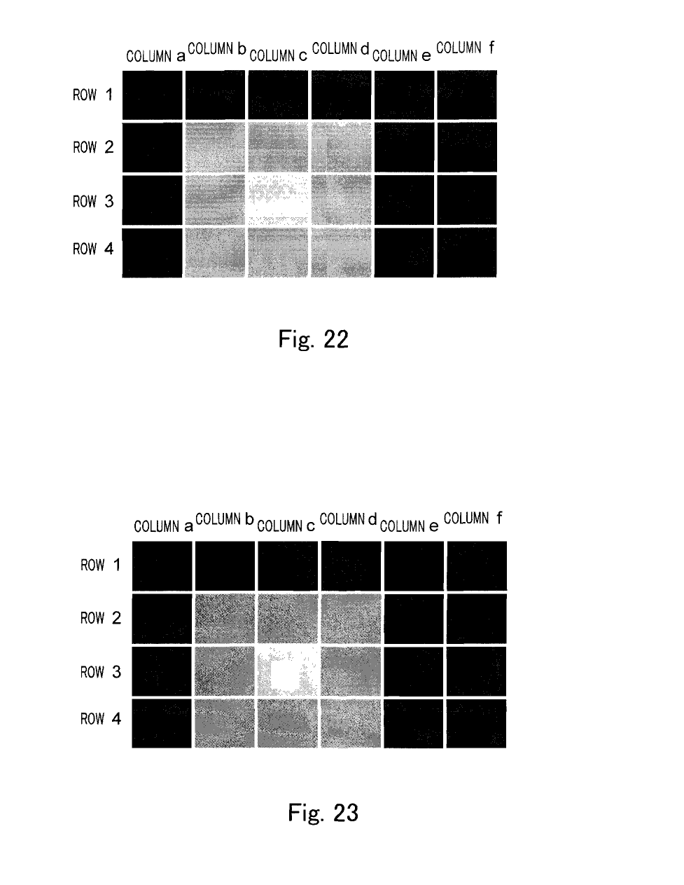

FIG. 22 shows the light emitting state of illuminating section 21 in case where the light emission brightness values shown in FIG. 20 are inputted in illuminating section 20. Further, FIG. 23 shows an image that is actually displayed on liquid crystal panel 10 when light in FIG. 22 illuminates liquid crystal panel 10 from its back.

As shown in FIG. 23, in case where weighting section 34 is used, the difference in light emission brightness values is alleviated between the light emitting areas that are not emitting light and light emitting area that is emitting light compared to FIG. 19 showing a case where weighting section 34 is not used. By this means, “less deep black” is alleviated.

<1-2-3. Update Control of Light Emission Brightness Values>

Next, the operation of update controlling section 40 for controlling the timings to update the light emitting state of light emitting section 21 will be explained.

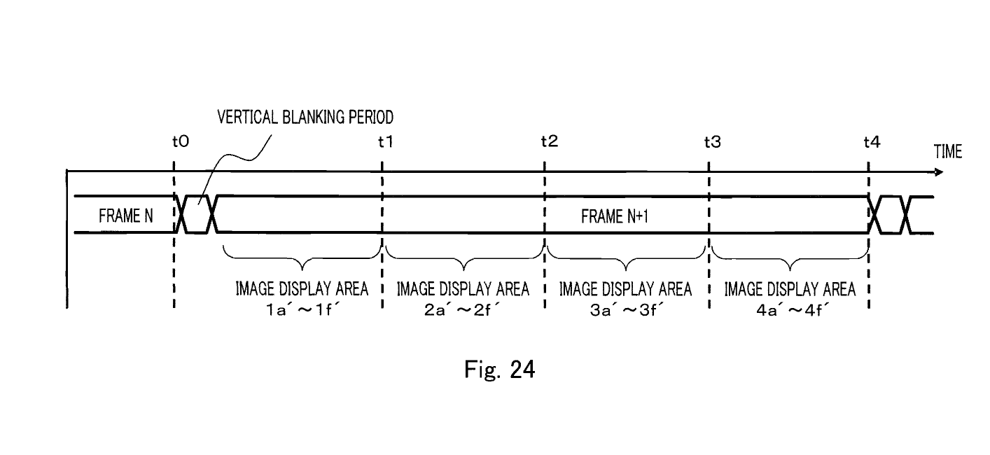

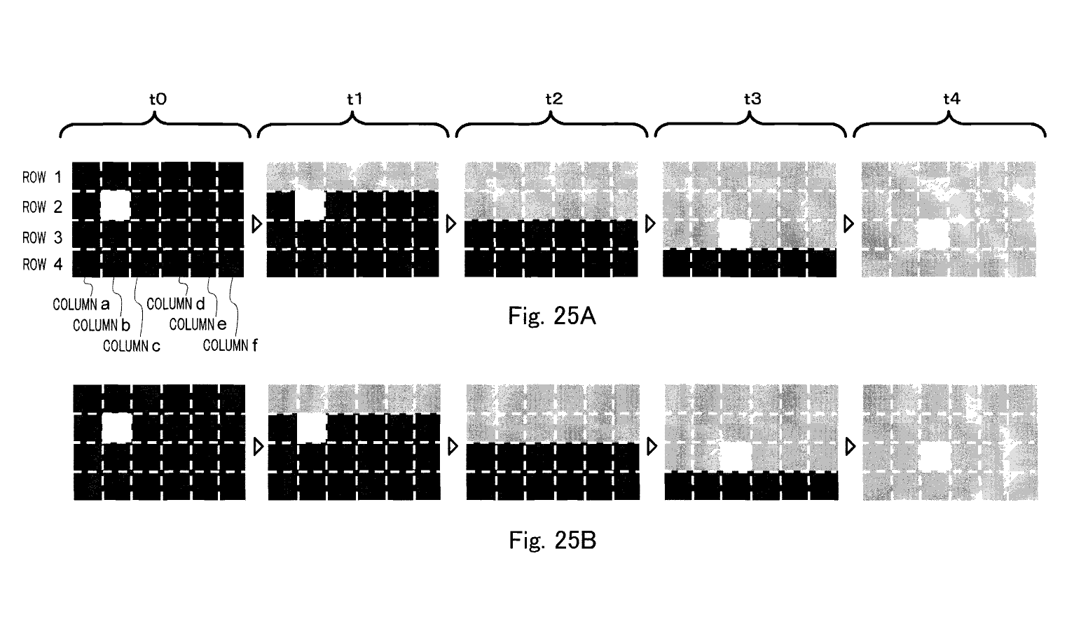

FIG. 24 shows how the input state of an image signal (i.e. input image signal) transitions. FIG. 25A and FIG. 25B show how the state of each image display area transitions. FIG. 25A shows how a transitional scan state of an input image signal transitions (how the scan state of liquid crystal panel 10 transitions). Further, FIG. 25B shows how content in temporary memory 33 transitions. Further, broken grid lines in FIG. 25A and FIG. 25B show the borders of image display areas (or light emitting areas).

FIG. 24 shows how the image is scanned from time t0 at which the writing scan of the image of an N-th frame, into liquid crystal panel 10 is finished, to time t4 at which the scan of the image of an N+1-th frame is finished. As shown in FIG. 25B, at time t0, temporary memory 33 is filled with reference brightness value data matching the image of an N-th frame. At time t1, an image signal matching image display areas 1a′ to 1f′ is inputted, reference brightness value data matching light emitting areas 1a to 1f is calculated, and the content in temporary memory 33 is updated. Similarly, at time t2, an image signal matching image display areas 2a′ to 2f′ is inputted, reference brightness value data matching light emitting areas 2a to 2f is calculated, and the content in temporary memory 33 is updated.

In this way, the content in temporary memory 33 is updated in synchronization with an input image signal and overwritten at virtually the same timing as the scan state of liquid crystal panel 10. That is, the content in temporary memory 33 represents the scan state of liquid crystal panel 10 as is.

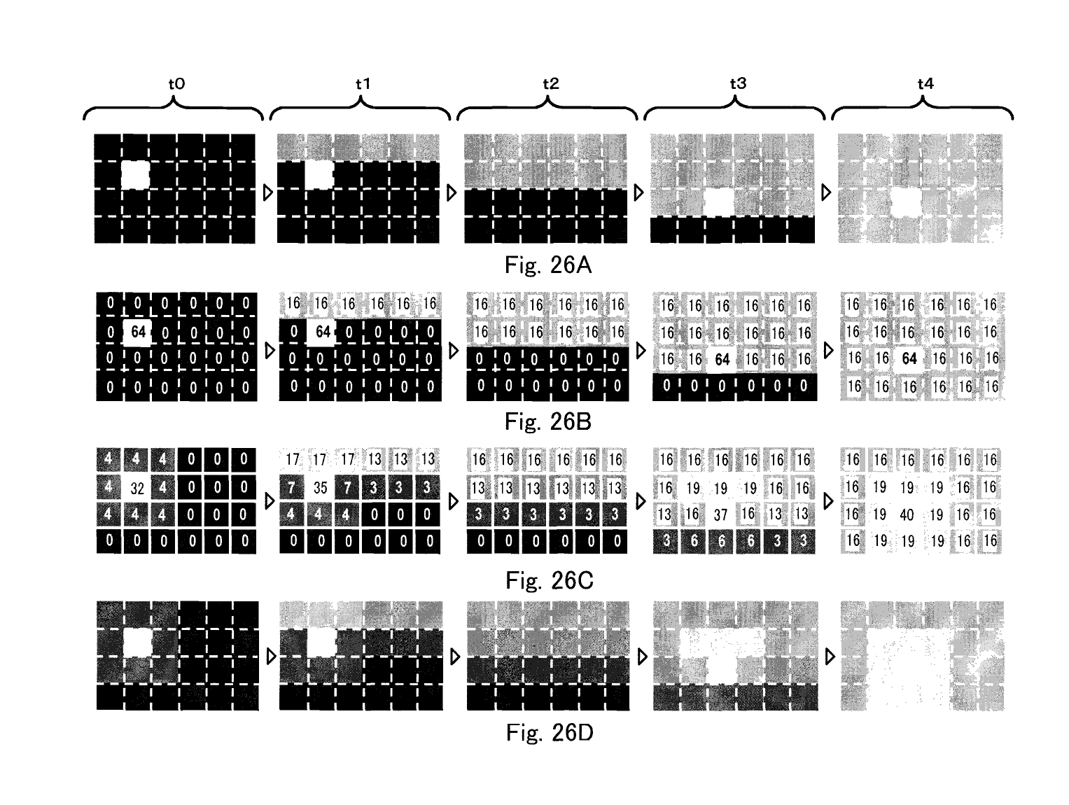

Next, the state of a display image that is actually displayed on liquid crystal panel 10 will be explained. FIG. 26A to FIG. 26D show how the state of each image display area transitions. Similar to FIG. 25A, FIG. 26A shows how a transitional scan state of an input image signal transitions (how a transitional scan state of liquid crystal panel 10 transitions). Similar to FIG. 25B, FIG. 26B shows how the content in temporary memory 33 transitions. FIG. 26C shows how the light emitting state of light emitting section 21 transitions. FIG. 26D shows how an image that is actually displayed on liquid crystal panel 10 transitions when light in FIG. 26C illuminates liquid crystal panel 10 from its back.

The numerical values shown in FIG. 26B are the reference brightness values stored in temporary memory 33. Further, the numerical values shown in FIG. 26C are the light emission brightness values acquired through weighting section 34. Weights that are used to calculate light emission brightness values are the same as the numerical values shown in FIG. 14.

Light emission brightness value data of all light emitting areas in light emitting section 21 acquired in weighting section 34 is transmitted to LED driver 22 at time t1, time t2, time t3 and time t4. Then, light emitted from light emitting section 21 is modulated in liquid crystal panel 10, so that the display image shown in FIG. 26D is acquired.

As is clear from comparison of FIG. 26A and FIG. 26C, the scan state of an image (the scan state of liquid crystal panel 10) and the light emitting state of light emitting section 21 are associated, without a mismatch, at each time of time t1 to t4. Consequently, it is possible to reduce the mismatch between an image and the light emitting state of light emitting section 21 in the process of scanning liquid crystal panel 10.

The operation of the liquid crystal display apparatus has been explained above.

<Summary of Characteristics>

Next, a characteristic advantage of the liquid crystal display apparatus according to the present invention will be illustrated.

For example, in case where light emitting areas of high brightness values and light emitting areas of low brightness values (particularly, light emitting areas having brightness values close to 0) adjoin each other in an input image signal, a conventional liquid crystal display apparatus decides whether to correct the light emission brightness values of light emitting areas having low brightness values by comparing the difference in brightness with a threshold. Therefore, as described above, there is a possibility that brightness becomes discontinuous in time.

The liquid crystal display apparatus according to the present invention does not use such a threshold, and therefore brightness does not become discontinuous.

Further, in case where light emitting areas of high brightness values and light emitting areas of low brightness values (particularly, light emitting areas of brightness values close to 0) adjoin each other in an input image signal, a conventional liquid crystal display apparatus corrects only the brightness values of light emitting areas of low brightness values to increase, without correcting brightness values of light emitting areas of high brightness values.

By contrast with this, the liquid crystal display apparatus according to the present invention functions to decrease light emission brightness values of light emitting areas of high average brightness values and increase light emission brightness values of light emitting areas of low average brightness values. According to this function, it is possible to reduce the increase in power due to brightness value correction compared to conventional configurations.

With the present embodiment in particular, the sum of weights applied to light emitting areas by the weighting section becomes one. Consequently, it is possible to apply weights in a state where the change in the amount of emission light radiated by the illuminating section is suppressed, and reduce extra power consumption.

With the present embodiment, an average brightness value is used as a feature value. In case where the average brightness value is used as the feature value, if a plurality of white objects of different areas are inputted in one image display area as the image signal, brightness of the light emitting area of a smaller white object becomes lower than that of the light emitting area of a larger white object.

However, the characteristics of human eyes generally tend to sense that a smaller white area is brighter than a larger white area when brightness is the same. Therefore, using an average brightness value as a feature value also results in a display free of unnaturalness.

Further, the liquid crystal display apparatus according to the present embodiment can acquire the same advantage even when a peak value of a brightness signal (hereinafter “peak brightness value”) in each pixel, which is included in the input image signal of each image display area, is used as a feature value. With a conventional configuration, if only peak brightness values are used, it is not possible to change brightness values according to the areas as described above. According to the present embodiment, brightness signals of surrounding light emitting areas are reflected, so that, even when the peak brightness values are used as feature values, it is possible to change brightness values according to areas. This will be described later.

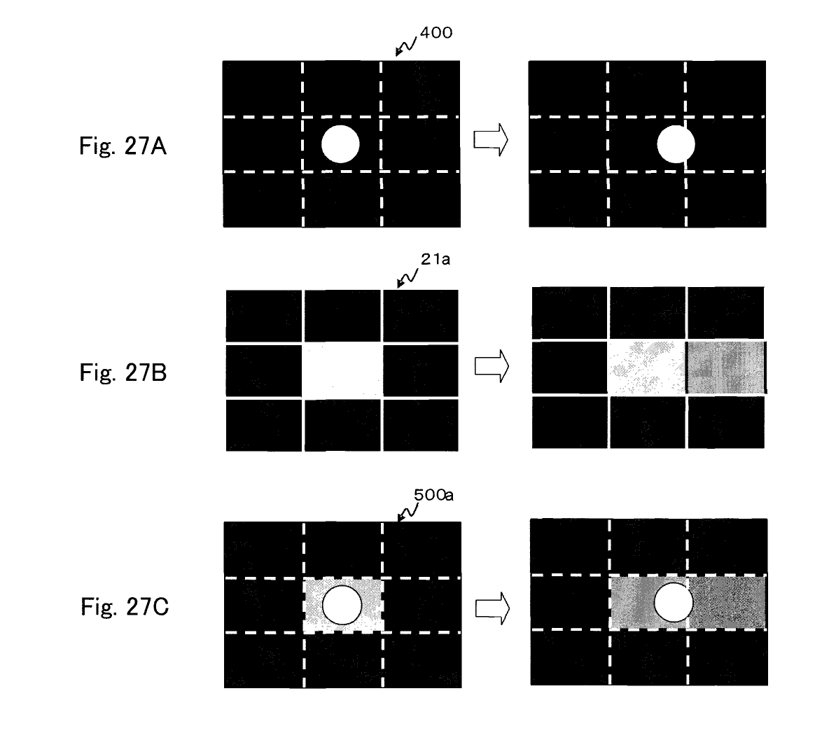

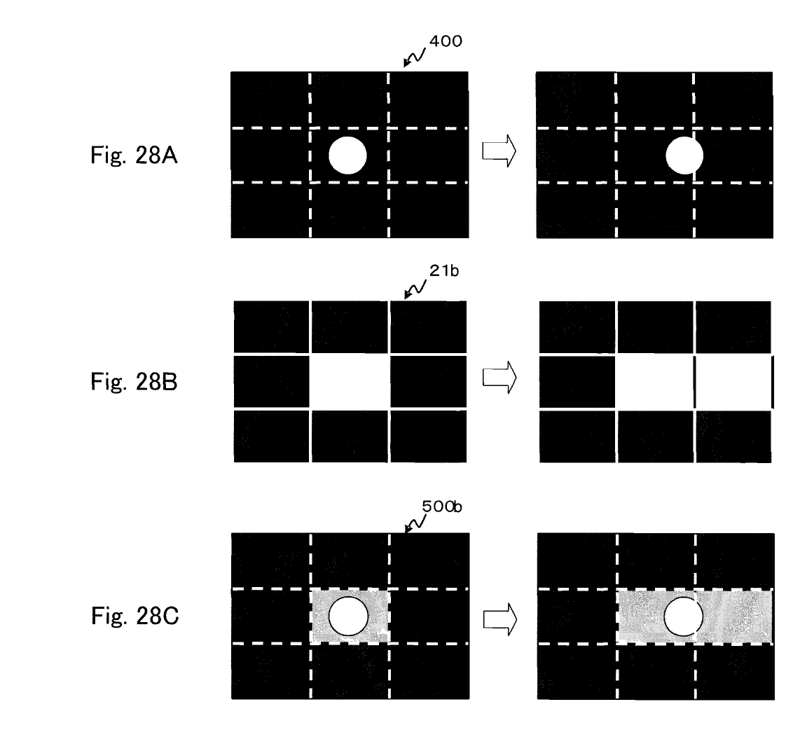

Further, an average brightness value and peak brightness value may be used in combination as a feature value. Furthermore, according to an input image signal of each image display area, it is also possible to change weights applied to the average brightness value and peak brightness value when these average brightness value and peak brightness value are added. The advantages of these configurations will be explained using FIG. 27A to FIG. 27C and FIG. 28A to FIG. 28C.

FIG. 27A to FIG. 27C illustrate the characteristics in case where an average brightness value is used as a feature value. FIG. 27A shows input image 400. In input image 400, there is a circular object with a high peak brightness on a black background. Note that the broken lines on input image 400 indicate the positions of divided areas of the backlight for ease of illustration, and are not included in the input image. FIG. 27B shows the light emitting state of light emitting section 21a, which is part of light emitting section 21, in case where an average brightness value is used as a feature value. Here, the area located in the center of light emitting section 21a includes the circular object with a high peak brightness of input image 400, and emits light at brightness matching the image of that area. Then, surrounding areas are turned off because the overall images of these areas are black. FIG. 27C shows display image 500a displayed in part of liquid crystal panel 10 in case where an average brightness value is used as a feature value.

FIG. 28A to FIG. 28C illustrate the characteristics in case where a peak brightness value is used as a feature value. FIG. 28A shows same input image 400 as in FIG. 27A. FIG. 28B shows the light emitting state of light emitting section 21b, which is part of light emitting section 21, in case where a peak brightness value is used as a feature value. Here, the area located in the center of light emitting section 21b includes a circular object with a high peak brightness of input image 400, and therefore emits light at brightness according to the image of that area. Then, surrounding areas are turned off because the overall images of these areas are black. FIG. 28C shows display image 500b displayed in part of liquid crystal panel 10 in case where a peak brightness value is used as a feature value.

As shown in FIG. 27C, in case where an average brightness value is used as a feature value, even when the object in the image moves, brightness of each light emitting area does not change steeply, and, consequently, a display is possible without unnaturalness. However, cases may occur where, in an image display area having a low average brightness value, a peak brightness of a very small white light spot of a high brightness value is insufficient (for example, an object like a star in the night sky).

By contrast with this, as shown in FIG. 28C, in case where peak brightness values are used as feature values, it is possible to maintain a peak brightness for an object like a star in the night sky. However, cases occur where, when an object in an image moves, brightness of each light emitting area changes steeply and a display becomes unnatural.

The following advantage is provided by utilizing these characteristics to combine an average brightness value and peak brightness value as a feature value or to change the weights applied to these average brightness value and peak brightness value according to an input image signal of each image display area. That is, it is possible to prevent peak brightness values from being locally insufficient according to an image to be displayed and prevent light from being emitted in an unnatural fashion according to the motion of the image, and, consequently, it is possible to adequately adjust the amount of light emitted from light emitting areas based on the optimal feature values.

Further, although LEDs are used as light sources with the present embodiment, the present invention is not limited to this. For example, laser light sources and fluorescent tubes may be used as light sources. That is to say, any light sources are contemplated which can control light emission brightness of divided light emitting areas. In case where a laser light source is used, it is possible to make an area for color reproduction wider. In case where fluorescent tubes are used, it is possible to make a liquid crystal panel thinner compared to the case where LEDs are aligned.

With the present embodiment, the liquid crystal display apparatus stores in the temporary memory a reference brightness value matching a feature value of an input image signal in each image display area, such that the reference brightness value matches the scan state of the liquid crystal panel. Further, the liquid crystal display apparatus calculates the light emission brightness value taking into account reference brightness values of surrounding light emitting areas according to the scan of the liquid crystal panel, and reflects brightness signals matching surrounding light emitting areas, in the light emission brightness value. By this means, it is possible to make the image match brightness of the backlight in the process of scanning the liquid crystal panel. As a result, it is possible to reduce the mismatch between brightness of the backlight and an image that is perceived as unnatural by the human eyes, and display quality images.

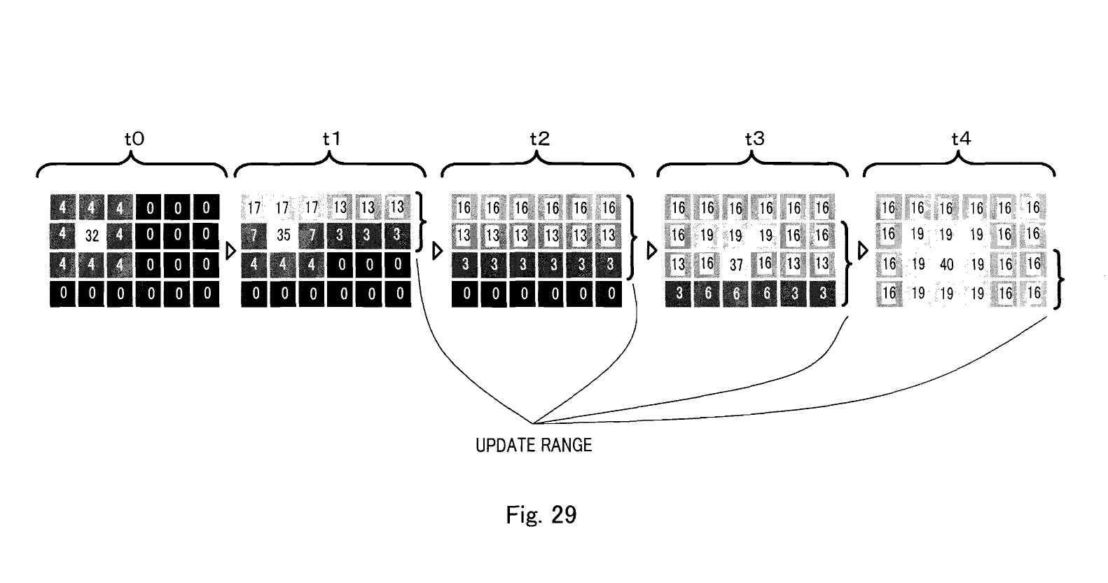

Further, although a method has been explained with the present embodiment using the examples explained in FIG. 26A to FIG. 26D where the light emitting states of all the light emitting areas are simultaneously updated at times t1 to t4, the present invention is not limited to this. In case where the second light emitting areas that are taken into account in the weighting section are areas of three rows and three columns around the first light emitting area, the method shown in FIG. 29 may be used.

As shown in FIG. 29, in all light emitting areas, the update controlling section updates only the light emitting states of light emitting areas in, for example, three rows including the row which includes the image display areas that are being scanned and upper and lower rows of that row. This is because the light emission brightness values change only in light emitting areas of three rows. That is to say, the update controlling section does not need to update the light emitting states of all light emitting areas, and only needs to update the light emitting states of light emitting areas of a row which includes at least the first image display area and second image display areas. In other words, the update controlling section only needs to update, on a per row basis, the light emitting states of the light emitting areas belonging to the row which includes at least the first light emitting area and second light emitting areas.

To explain this further, in case where the second light emitting areas form an area of P rows and Q columns (where P and Q are positive integers) around the first light emitting area, the update controlling section only needs to update, on a per row basis, the light emitting states of the light emitting areas matching the range of P rows around the row which includes at least first image display area. Also in this case, in the process of scanning, it is possible to acquire an advantage obtained by making the image and light emission brightness match. That is, it is possible to reduce the mismatch between an image and brightness of the backlight that is perceived by human eyes as unnatural, and acquire an advantage of displaying quality images in the same way as in the case where the light emitting states of all light emitting areas are updated.

Further, methods other than the above for updating each light emitting state of the light emitting area a plurality of times while all image display areas in the optical modulating section are scanned once according to an input image signal.

Further, although the update controlling section updates the light emitting states of the light emitting areas of four rows and six columns four times, the number of which matches the number of rows, the present invention is not limited to this. For example, the update controlling section may update the light emitting states once every time the image in a plurality of rows is scanned. To be more specific, in case of the present embodiment, the update controlling section may update the light emitting states once every time the image in two rows is scanned. That is, the update controlling section may update the light emitting state twice per frame. By so doing, it is possible to make the processing speed of update control lower and, consequently, simplify a circuit and reduce cost.

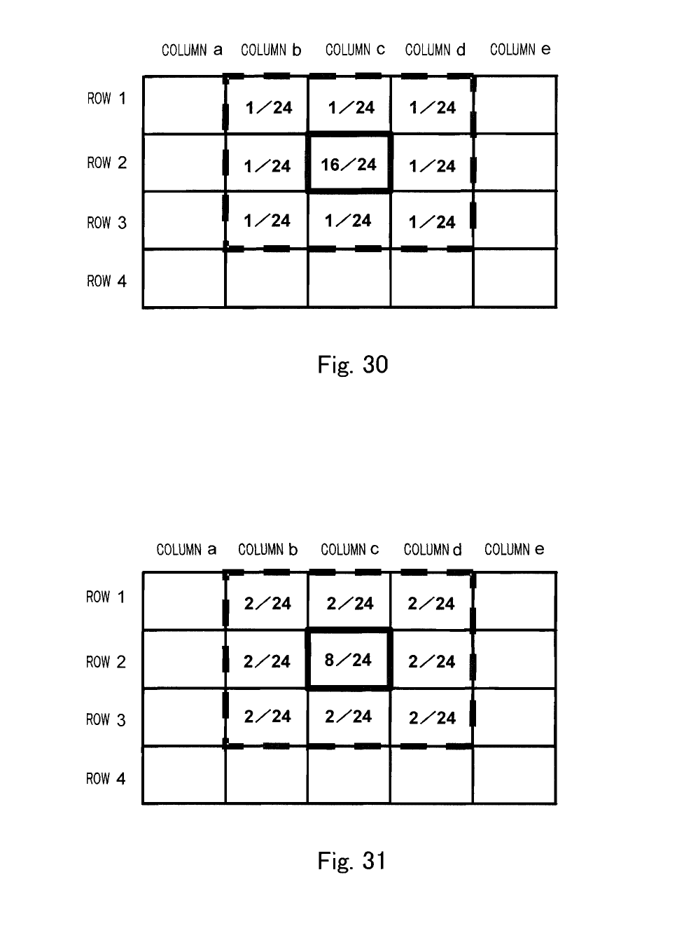

Further, although, with the present embodiment, the weighting section applies the 8/16 weight to the reference brightness value of the first light emitting area and applies the 1/16 weight to the reference bright values of the second light emitting areas, the present invention is not limited to this. In case where it is necessary to increase the first weight and decrease second weights, weights may be set as shown in, for example, FIG. 30. FIG. 30 illustrates weights in case of M:N=2:1.

By contrast with this, in case where it is necessary to decrease the first weight and increase second weights, the weighting section only needs to apply weights as shown in, for example, FIG. 31. FIG. 31 illustrates the first weight and the second weights in case of M:N=1:2.

These weights may be changed according to an input image signal of each image display area. The specific numerical values of weights other than the above may be possible. Further, in case where the overall brightness needs to be increased, the first weight and the second weights may be determined such that the sum of weights becomes one or more. By contrast with this, in case where the overall brightness needs to be decreased, the first weight and the second weights may be determined such that the sum of weights becomes one or less.

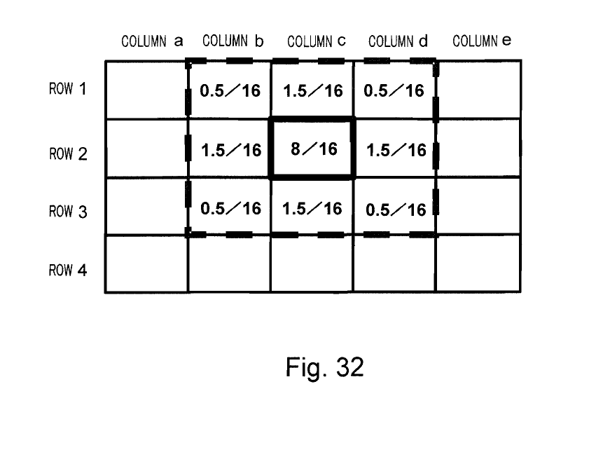

Further, although, with the present embodiment, the weighting section makes the second weights the same, the present invention is not limited to this. As shown in FIG. 32, for example, the weighting section may make the second weights for the second light emitting areas (i.e. light emitting areas 1b, 1d, 3b and 3d) located diagonally with respect to the first light emitting area (i.e. light emitting area 2c), lower than the second weights for the other second light emitting areas. That is, the weighting section may change weights per second light emitting area.

The substantial distance between the first light emitting area and second light emitting areas located diagonally is a little longer than the other second light emitting areas. Consequently, by decreasing weights for the reference brightness values of the second light emitting areas located diagonally, an image display is possible with much less unnaturalness.

Further, although, with the present embodiment, the weighting section applies weights to the reference brightness values of light emitting areas of three rows and three columns assuming that the eight surrounding areas around the first light emitting area are second light emitting areas, the present invention is not limited to this. The weighting section may change the number of light emitting areas such as five rows and five columns or five rows and three columns that are assigned weights. In this case, by providing an odd number of rows and an odd number of columns, it is possible to place second light emitting areas symmetrically with respect to the first light emitting area in the row direction and the column direction.

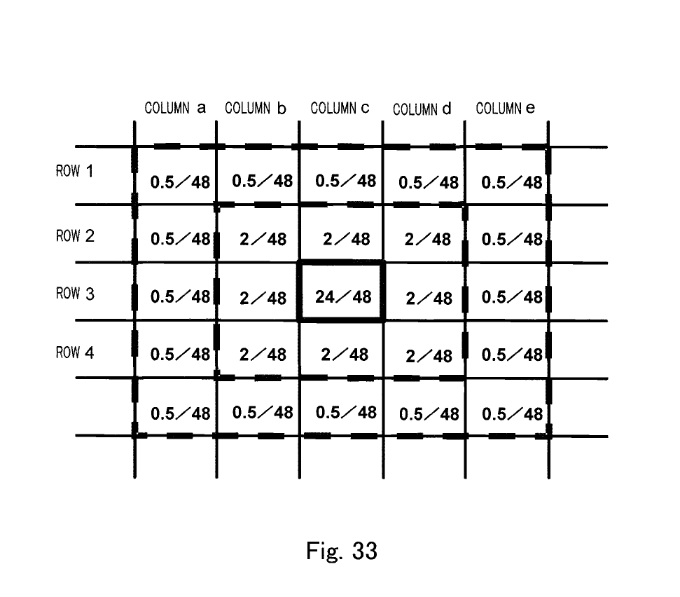

FIG. 33 illustrates a case where the reference brightness values of light emitting areas of five rows and five columns that are assigned weights. At this time, the weighting section applies lower weights to reference brightness values of second light emitting areas located farther away from the first light emitting area. By so doing, an image display is possible with much less unnaturalness.

Further, although, with the present embodiment, the second light emitting areas are eight surrounding areas around the first light emitting area, the present invention is not limited to this. For example, weights may be applied by assuming that all light emitting areas including the first light emitting area as the second light emitting areas and using an average value of brightness signals of the entire screen as second information.

By so doing, it is possible to change brightness of each light emitting area according to an average value of brightness signals of the entire screen. Consequently, it is possible to display, for example, an image close to all-white display that increases power consumption of the backlight, at the reduced light emission brightness while saving power. Further, in an image in which there are some very small white light spots from place to place on a black background that decreases power consumption of the backlight apparatus, it is possible to display the white portions brightly by concentrating power only on the areas with white light spots. In this way, liquid crystal display apparatus 1 can provide expressive images by making all the light emitting areas second light emitting areas.

Further, although, with the present embodiment, liquid crystal display apparatus 1 calculates light emission brightness values using virtual extended light emitting areas for light emitting areas at the end parts in light emitting section 21 and assuming that there are light emitting areas in surrounding eight directions of all the light emitting areas, other calculation methods may be used. For example, without using all of the eight surrounding directions, the weighting section may apply weights only to the reference brightness values of the second light emitting areas that are present. Further, liquid crystal display apparatus 1 may not use the weighting section for the light emitting areas at the end parts.

Further, although, with the present embodiment, the weighting section applies certain weights, these weights may be changed by some factors. For example, the weighting section may change weights based on the difference between the first information and second information. When the difference between the first information and the second information is greater, “less deep black” is more likely to be seen. Consequently, when the difference between the first information and the second information is greater, it is possible to prevent “less deep black” from being seen by increasing the second weights.

### Embodiment 2

Next, Embodiment 2 (an embodiment of applying weights to reference feature values), which is an example where the present invention is applied to a liquid crystal display apparatus, will be explained with reference to the accompanying drawings. Embodiment 2 differs from Embodiment 1 in the configuration of brightness determining section 30 shown in FIG. 9. The configurations of the rest of the parts are the same as in Embodiment 1, and part of explanation will be omitted.

Note that, while reference brightness values calculated in the brightness calculating section are applied weights with Embodiment 1, feature values of an image signal prior to being inputted in the brightness calculating section are applied weights with Embodiment 2.

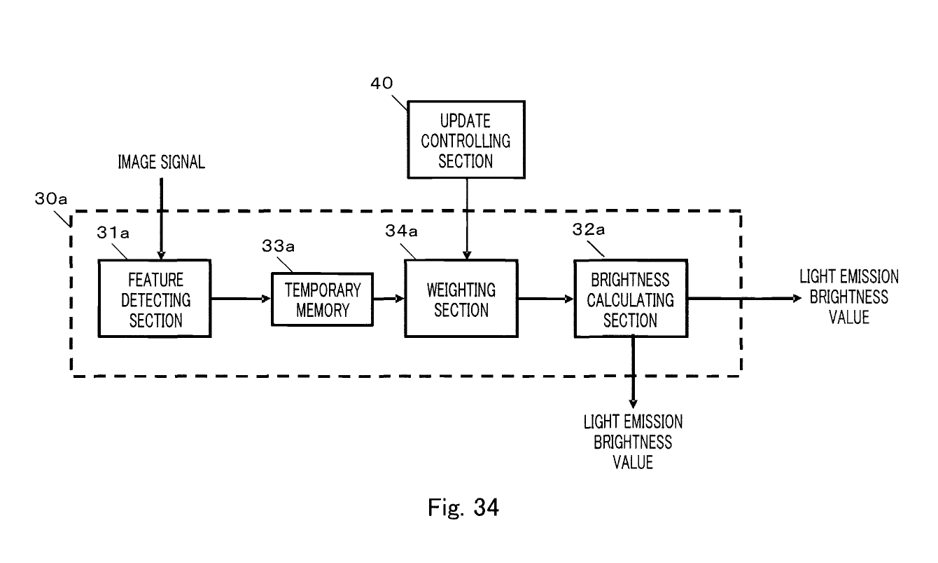

FIG. 34 is a configuration diagram showing the specific configuration of brightness determining section 30a. Roughly, brightness determining section 30a has feature detecting section 31a, temporary memory 33a, weighting section 34a and brightness calculating section 32a.

Feature detecting section 31a has the same function as feature detecting section 31 in Embodiment 1. That is, feature detecting section 31a detects the average brightness value per image display area. Feature detecting section 31a outputs the detected average brightness value of each image display area, sequentially, to temporary memory 33a as the reference feature value. The “reference feature value” is a value which serves as a reference when feature values of an image signal in each image display area are calculated.

Temporary memory 33a stores the reference feature value outputted from feature detecting section 31a. That is, temporary memory 33a sequentially stores the reference feature value per image display area, and stores the reference feature values of all image display areas on a temporary basis.

Weighting section 34a determines the feature value of the first image display area, from the values acquired by applying weights to the first information (i.e. the reference feature value of the first image display area) and the second information (i.e. reference feature values of the second image display areas). That is, to determine the feature value of one image display area (i.e. the first image display area), weighting section 34a retrieves from temporary memory 33a the reference feature value (i.e. the first information) for that image display area. Further, weighting section 34a retrieves from temporary memory 33a the reference feature values (i.e. the second information) of predetermined image display areas (i.e. second image display areas) different from that image display area. Then, weighting section 34a applies weights to a plurality of retrieved reference feature values (i.e. the first information and second information) and adds the results to determine the feature value of that image display area (i.e. the first image display area).

With the present embodiment, the second image display areas refer to the eight neighboring image display areas surrounding the first image display area. For example, to illustrate using FIG. 10B, in case where image display area 3d′ is the first image display area, the second image display areas are image display areas 2c′, 2d′, 2e′, 3c′, 3e′, 4c′, 4d′ and 4e′.

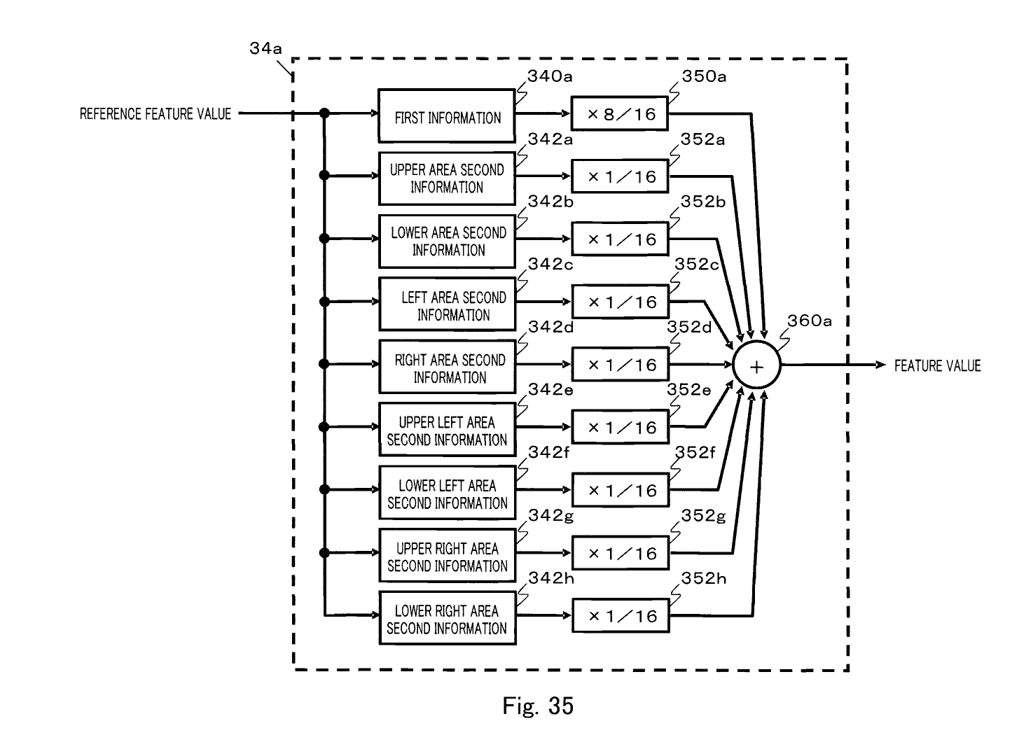

FIG. 35 is a configuration diagram showing a more specific configuration of weighting section 34a according to the present embodiment. Weighting section 34a has first information retrieving block 340a, eight second information retrieving blocks 342a, 342b, 342c, 342d, 342e, 342f, 342g and 342h, first information weighting block 350a, eight second information weighting blocks 352a, 352b, 352c, 352d, 352e, 352f, 352g and 352h, and adding block 360a.

First information retrieving block 340a retrieves the first information from temporary memory 33a. First information weighting block 350a applies a weight to the retrieved first information and outputs the first reference feature value.

Second information retrieving blocks 342a to 342h each retrieve second information from temporary memory 33a. Second information weighting blocks 352a to 352h each apply a weight to the retrieved second information and output a second reference feature value.

Adding block 360a adds the first reference feature value outputted from first information weighting block 350a and the second reference feature values outputted from second information weighting blocks 352a to 352h.

With the present embodiment, first information weighting block 350a applies the 8/16 weight to the first information. Further, second information weighting blocks 352a to 352h each apply the 1/16 weight equally to all items of the second information. The second information is the reference feature value of each of eight neighboring image display areas surrounding the first image display area.

The weighting method is the same as the weighting method explained in FIG. 14 of Embodiment 1. That is, according to the weighting method of the present embodiment, light emitting areas are replaced with image display areas in the weighting method explained using FIG. 14.

Weighting section 34a applies a weight to the reference feature value of each image display area, and outputs the value (i.e. feature value) to which a weight is applied, to brightness calculating section 32a.

Brightness calculating section 32a calculates the light emission brightness value per light emitting area, based on the input feature value. That is, per image display area, brightness calculating section 32a converts the feature value into the light emission brightness value of a light emitting area associated with an applicable image display area, and outputs the light emission brightness value to LED driver 22 of illuminating section 20 and image signal correcting section 50. The conversion tables provided in the brightness calculating section are the same as in brightness calculating section 32 of Embodiment 1, and therefore explanation thereof will be omitted.

With this configuration, although there is a difference as to whether to apply a weight to the feature value of an image signal of each image display area or to apply a weight to the light emission brightness value of each light emitting area associated with each image display area, it is possible to acquire the same advantage as in Embodiment 1 as a result. That is, in case where an image signal of an image shown in FIG. 16 is inputted, the light emission brightness values of the light emitting areas shown in FIG. 20 are determined.

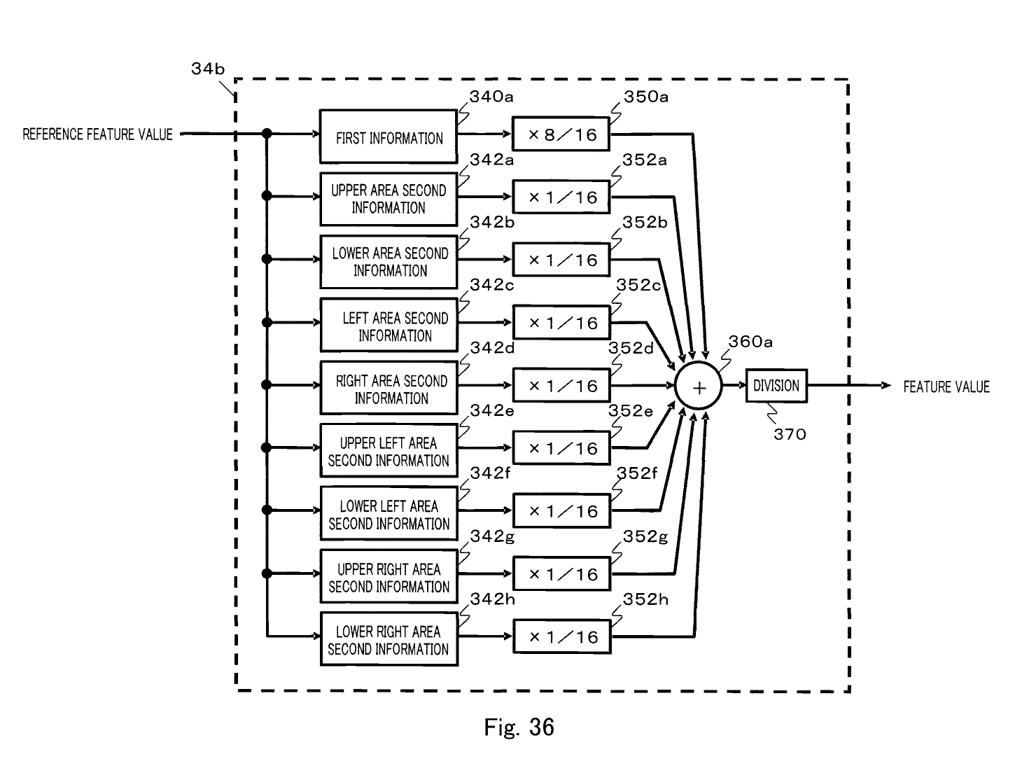

Note that, with the present embodiment, instead of an average brightness value, a total of brightness signals (hereinafter “total brightness value”) of pixels in each image display area may be used as a reference feature value. In this case, using a total brightness value as a reference feature value, the weighting section converts this total brightness value into an average value. FIG. 36 shows a specific configuration.

FIG. 36 is a configuration diagram showing the configuration of weighting section 34b used in case where a total brightness value is used as a reference feature value. Weighting section 34b differs from weighting section 34a in having dividing block 370.

In case where the total brightness value is used as a reference feature value, the first information and second information each serve as a total brightness value. Therefore, dividing block 370 of weighting section 34b averages the value outputted from adding block 360a to make the result correspond to the feature value matching one image display area. That is, dividing block 370 divides the addition result in adding block 360a, by the number of pixels in liquid crystal panel 10 included in all of the first image display area and eight second image display areas. This configuration can acquire the same result.

With the present embodiment, similar to Embodiment 1, update controlling section 40 outputs update timing pulses to the weighting section. Therefore, every time update timing pulses are inputted, brightness calculating section 32a calculates light emission brightness values and outputs the results to LED driver 22.

Note that a configuration is possible where update controlling section 40 outputs update timing pulses to brightness calculating section 32a.

### Embodiment 3

Next, Embodiment 3 which is an example where the present invention is applied to a liquid crystal panel will be explained with reference to the accompanying drawings. Embodiment 3 differs from Embodiment 1 in timings to update the light emitting state of the illuminating section. The same components as in Embodiment 1 will not be explained partially.

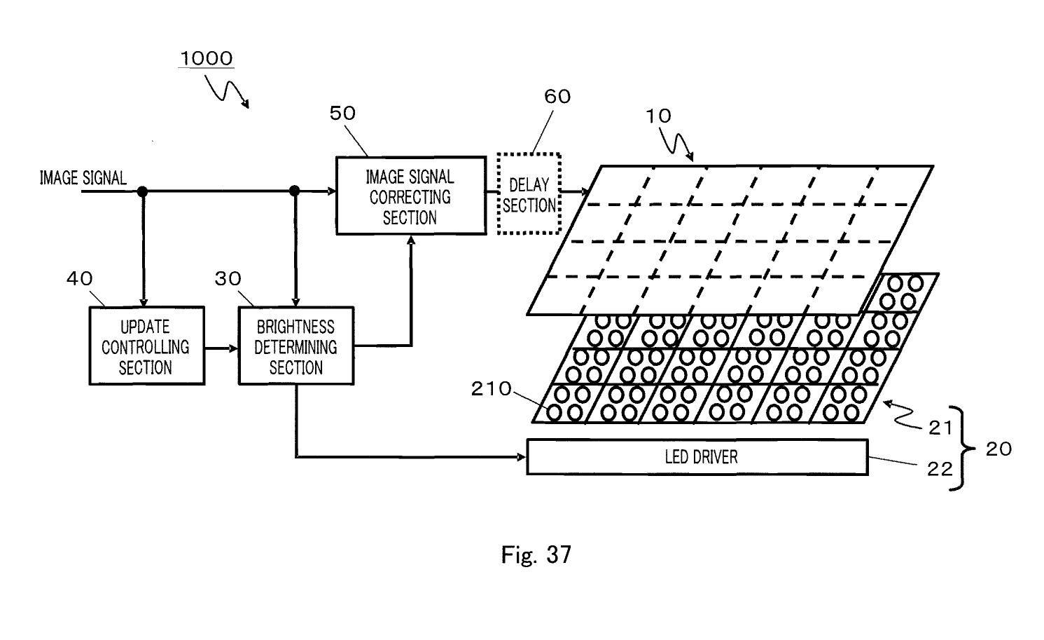

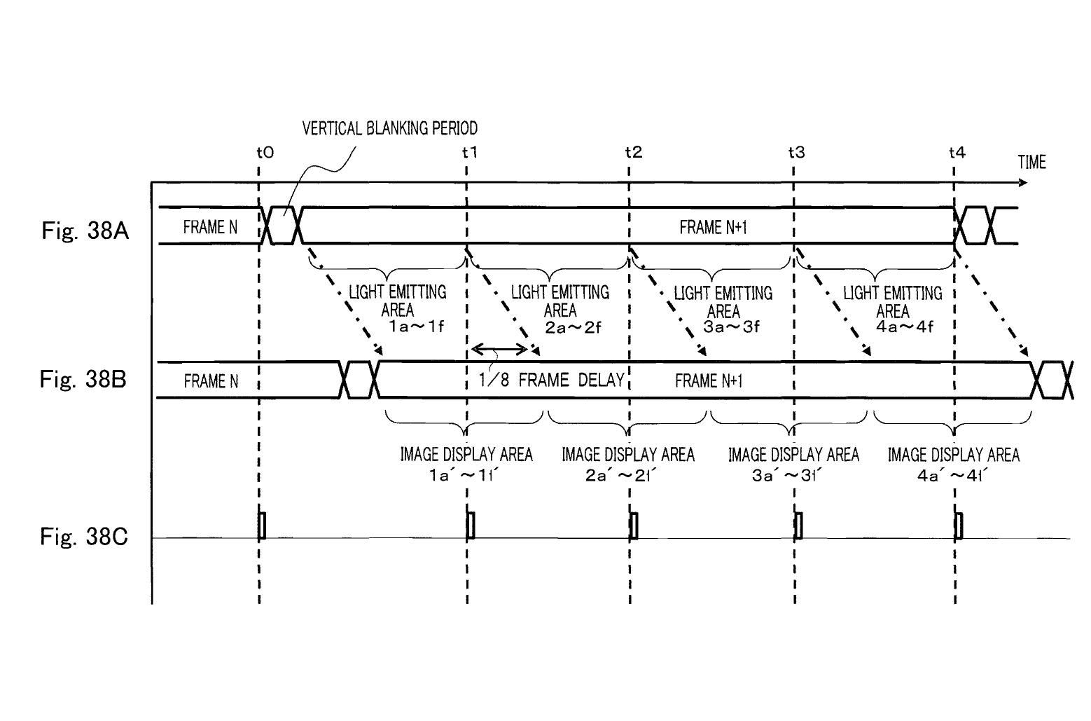

With the present embodiment, the update controlling section updates light emitting states while rows formed with a plurality of image display areas are being scanned. That is, while a certain number of image display areas are being scanned, the update controlling section updates light emitting states of light emitting areas associated with a plurality of image display areas. This configuration and its operation will be explained using FIG. 37 and FIG. 38A to FIG. 38C.

FIG. 37 is a configuration diagram showing the overall configuration of liquid crystal apparatus 1000 in case where light emitting states are updated while the rows are being scanned. Liquid crystal display apparatus 1000 has delay section 60 subsequent to image signal correcting section 50. Delay section 60 delays an image signal outputted from image signal correcting section 50 by a predetermined period.

FIG. 38A to FIG. 38C illustrate the relationship between the scan of liquid crystal panel 10 and timings to update light emitting states according to the present embodiment. FIG. 38A shows how an image signal is inputted when light emission brightness values are calculated. FIG. 38B shows the state of an input image to be scanned in liquid crystal panel 10. FIG. 38C shows timings to output update timing pulses. FIG. 38A to FIG. 38C show comparison on the same time domain. The light emitting states can be updated after light emission brightness values are calculated. Therefore, similar to Embodiment 1, update timing pulses are generated after the light emission brightness values shown in FIG. 38A are calculated.

With Embodiment 1, the calculation of the light emission brightness values shown in FIG. 38A and the scan of liquid crystal panel 10 shown in FIG. 38B are performed at the same timing. However, with the present embodiment, liquid crystal display apparatus 1000 delays only the timings to scan liquid crystal panel 10 shown in FIG. 38B using delay section 60. With the present embodiment, while image display areas belonging to one row are being scanned, update timing pulses are inputted in liquid crystal panel 10 in the middle of scanning (that is, in the middle of a row). That is, the present embodiment provides a configuration of four rows of image display areas, and one row corresponds to one fourth of a frame and therefore the delay amount by delay section 60 is half, one eighth of a frame.

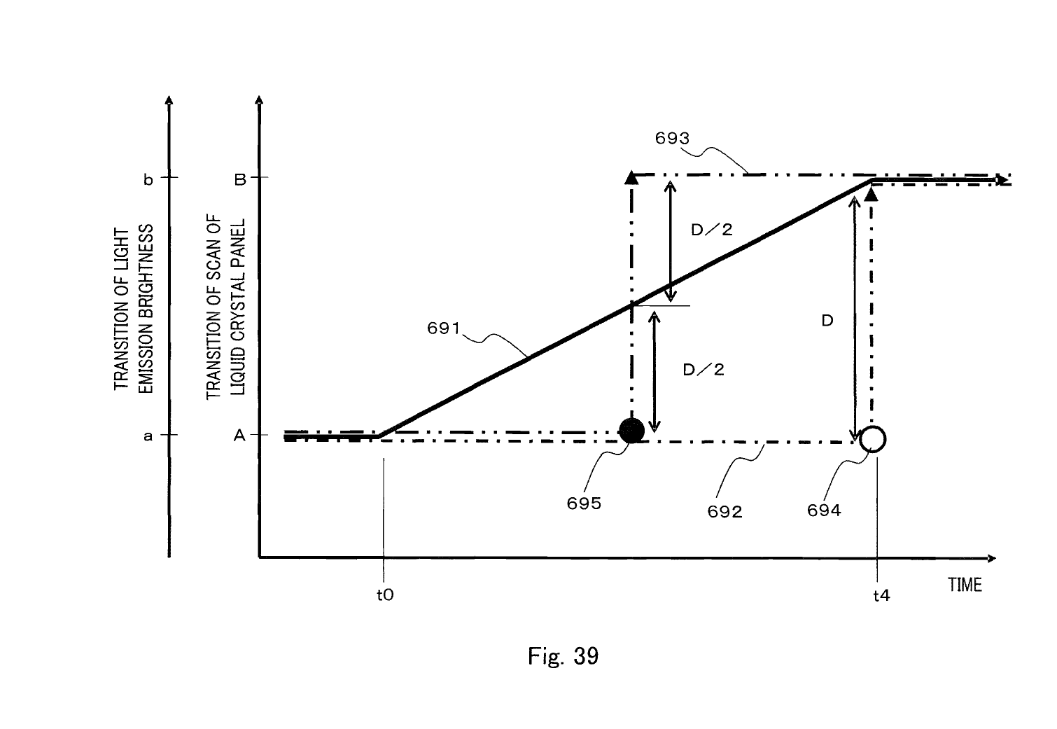

Next, the advantage of the present embodiment will be explained using FIG. 39.

FIG. 39 illustrates the advantage of updating the light emitting states while the rows are being scanned. In FIG. 39, the horizontal axis represents time and the vertical axis represents two axes for transition of a scan in the liquid crystal panel and transition of the light emission brightness.

To be more specific, FIG. 39 schematically shows using solid line 691 how the scan of the liquid crystal panel transitions when it is assumed that, from time t0 to time t4, an image signal of image display areas belonging to a predetermined row transitions from A state to B state. Further, FIG. 39 schematically shows using dashed dotted line 692 (in case where light emitting states are updated after the scan) and dashed-two dotted line 693 (in case where light emitting states are updated during the scan) how light emission brightness transitions when it is assumed that light emission brightness of light emitting areas belonging to that row transition from a to b. Note that white circle 694 represents an update timing in case where light emitting states are updated after the scan. Further, black circle 695 represents an update timing in case where light emitting states are updated during the scan.

In this figure, the state where solid line 691 representing an input image signal match with each dotted line 692 and 693 representing light emission brightness represents the state where the image and the light emission brightness match. That is, although the image and light emission brightness match before the state transitions to state A and after the state transitions to state B (that is, before time t0 and after time t4), there is a difference in how light emission brightness transitions between this time (that is, between time t0 and time t4).

In case where light emitting states are updated after the scan, that is, at the timing indicated by white circle 694, the level of the mismatch between an image and light emission brightness (i.e. difference between solid line 691 and dotted line 692) gradually increases while state A transitions to state B. Then, immediately before a scan period of that row ends (i.e. immediately before time t4), the level of the mismatch between an image and light emission brightness reaches the level of the mismatch indicated by D in FIG. 39. Afterward, at time t4, light emitting states are updated and the mismatch between an image and light emission brightness is fixed.

By contrast with this, in case where light emitting states are updated during the scan, while state A is transitioning to state B, the level of the mismatch between an image and light emission brightness (the difference between solid line 691 and dashed-two dotted line) gradually degreases after the update timing indicated by black circle 695. Then, this mismatch is solved at time t4. That is, in case where light emitting states are updated during the scan, the transitional maximum level of the mismatch during the scan decreases compared to the case where light emitting states are updated after the scan. Particularly, as described with the present embodiment, by making the degree of delay in delay section 60 half of the scan period for one row (i.e. one eighth of a frame with the present embodiment), it is possible to make the maximum level of the mismatch D/2. That is, a configuration for minimizing the level of the mismatch is made possible. By this means, it is possible to provide a more quality image display.

Further, delay section 60 is not required in Embodiment 1 and, consequently, it is possible to simplify the configuration and acquire an advantage of lowering cost.

### Other Embodiments

As described above, Embodiments 1 to 3 have been illustrated as embodiments of the present invention. However, the present invention is not limited to these embodiments. Therefore, summary of one of other embodiments will be explained below.

The liquid crystal display apparatus according to another embodiment has the same configuration as in Embodiment 1 in which a feature detecting section determines the feature value per image display area by applying weights to an average brightness value and peak brightness value. Further, this liquid crystal display apparatus further has an outdoor light detecting section, and employs a configuration of changing weights applied to these average brightness value and peak brightness value according to the detected outdoor light luminance.

With this configuration, in case where outdoor light luminance is high to an extent that “less deep black” is not noticeable, a weight applied to a peak brightness value is increased, so that a feature value of a minute white light spot can be increased to emit bright light. Consequently, it is possible to provide an optimal image matching outdoor light luminance.

Further, the liquid crystal display apparatus according to another embodiment has the same configuration as in Embodiment 1, and employs a configuration where a feature detecting section determines feature values by applying weights to an average brightness value and peak brightness value per image display area. Further, this liquid crystal display apparatus employs a configuration for changing the first weight and second weights in a weighting section, depending on the weights applied to these average brightness value and peak brightness value.

By increasing the second weights when, for example, a weight applied to a peak brightness value is high, this configuration can provide an advantage of improving the steep change in brightness of light emitting areas that is produced when an object moves in case where a weight applied to the peak brightness value is increased. Consequently, it is possible to ensure both maintenance of peak brightness and smooth motions on light emitting areas according to the motion of an image.

Further, although, with above Embodiment 1 to Embodiment 3, weights shown in, for example, FIG. 14, FIG. 30, FIG. 31, FIG. 32 and FIG. 33, are applied to the first light emitting area and second light emitting areas, the present invention is not limited to this. For example, assuming a feature value of each image display area as image data, the liquid crystal display apparatus may reflect brightness signals of surrounding image display areas (i.e. second image display areas) in the light emission brightness of an image display area of interest (i.e. first image display area) using a band limiting filter. In this case, filter coefficients of the band limiting filter correspond to the weights in the above-described embodiments. To be more specific, for example, in case where a band limiting filter of horizontal three taps (i.e. three areas in the row direction) and vertical three taps (i.e. three areas in the column direction) is employed, the values shown in FIG. 14 correspond to filter coefficients.

### INDUSTRIAL APPLICABILITY

The backlight apparatus and display apparatus according to the present invention can be utilized as a display apparatus for a liquid crystal television and liquid crystal monitor, and a backlight apparatus thereof.

### REFERENCE SIGNS LIST

1, 1000 LIQUID CRYSTAL DISPLAY APPARATUS
10 LIQUID CRYSTAL PANEL
20 ILLUMINATING SECTION
21, 21a, 21b LIGHT EMITTING SECTION
22 LED DRIVER
30, 30a BRIGHTNESS DETERMINING SECTION
31, 31a FEATURE VALUE VALUE DETECTING SECTION
32, 32a BRIGHTNESS CALCULATING SECTION
33, 33a TEMPORARY MEMORY
34, 34a, 34b WEIGHTING SECTION
40 UPDATE CONTROLLING SECTION
50 IMAGE SIGNAL CORRECTING SECTION
60 DELAY SECTION
210 LED
340, 340a FIRST INFORMATION RETRIEVING BLOCK
341a to 341h, 342a to 342h SECOND INFORMATION RETRIEVING BLOCK
350, 350a FIRST INFORMATION WEIGHTING BLOCK
351a to 351h, 352a to 352h SECOND INFORMATION WEIGHTING BLOCK
360, 360a ADDING BLOCK
370 DIVIDING BLOCK
400 INPUT IMAGE
500a, 500b DISPLAY IMAGE
800, 900 INPUT IMAGE
810, 910 BACKLIGHT
820, 920 DISPLAY IMAGE

1. A backlight apparatus comprising:
an illuminating section that radiates illuminating light to display an image, on an optical modulating section which comprises a plurality of image display areas and which displays an image by modulating per image display area illuminating light, which is radiated from a back of the light modulating section, according to an image signal;
a brightness determining section that determines a light emission brightness value of the illuminating section and updates a light emitting state of the illuminating section based on the determined light emission brightness value; and
an update controlling section that controls a timing to update the light emitting state, wherein:
the illuminating section comprises a plurality of light emitting areas illuminating the plurality of image display areas, respectively;
the brightness determining section determines a light emission brightness value of a light emitting area illuminating a first image display area, from values acquired by applying weights to first information based on an input image signal of the first image display area and second information based on an input image signal of a second image display area; and
the update controlling section makes the brightness determining section update each light emitting state of the plurality of light emitting areas a plurality of times while all image display areas of the optical modulating section are scanned once according to the input image signal.

2. The backlight apparatus according to claim 1, wherein the update controlling section makes the brightness determining section perform simultaneous update of light emitting states of all light emitting areas a plurality of times while all the image display areas of the optical modulating section are scanned once according to the input image signal.

3. The backlight apparatus according to claim 1, wherein:
the optical modulating section has a plurality of rows each comprised of the plurality of image display areas; and
the update controlling section makes the brightness determining section update light emitting states of the row according to a scan of the row.

4. The backlight apparatus according to claim 3, wherein the update controlling section makes the brightness determining section update light emitting states of the row during the scan of the row.

5. The backlight apparatus according to claim 3, wherein, in case where one of a plurality of image display areas belonging to a same row is the first image display area, every time at least one or more rows are scanned, the update controlling section makes the brightness determining section update at least light emitting states of a plurality of light emitting areas illuminating image display areas belonging to a row including the first image display area and the second image display area.

6. The backlight apparatus according to claim 1, wherein the brightness determining section comprises:
a feature detecting section that detects a feature value of an input image signal of each image display area;
a brightness calculating section that calculates a reference brightness value of each light emitting area based on the feature value; and
a weighting section that determines the light emission brightness value of the first light emitting area, from values acquired by applying weights to a reference brightness value of the first light emitting area, which is the first information, and a reference brightness value of the second light emitting area, which is the second information.

7. The backlight apparatus according to claim 1, wherein the brightness determining section comprises:
a feature detecting section that detects a reference feature value of an input image signal of each image display area;
a weighting section that determines a feature value of the first image display area, from values acquired by applying weights to a reference feature value of a first image display area, which is the first information, and a reference feature value of a second image display area, which is the second information; and
a brightness calculating section that calculates a light emission brightness value of each light emitting area based on the feature value.

8. The backlight apparatus according to claim 1, wherein the second image display area includes an image display area adjacent to the first image display area.

9. The backlight apparatus according to claim 1, wherein the brightness determining section applies a lower weight than a weight applied to the first information, to the second information.

10. The backlight apparatus according to claim 1, wherein the brightness determining section applies a lower weight to second information of the second image display area that is farther away from the first image display area.

11. The backlight apparatus according to claim 1, wherein the brightness determining section changes weights applied to the first information and the second information, based on the first information and the second information.

12. The backlight apparatus according to claim 1, wherein:
the brightness determining section comprises:
a feature detecting section that detects a feature value of an input image signal of each image display area;
a brightness calculating section that calculates a reference brightness value of each light emitting area based on the feature value; and
a storing section that stores the reference brightness value; and
the storing section has storing areas associated with the plurality of image display areas and updates content of the storing section in synchronization with a scan state of the optical modulating section.

13. A display apparatus comprising:
the backlight apparatus according to claim 1; and
the optical modulating section.

14. The display apparatus according to claim 13, further comprising an image signal correcting section that corrects an image signal inputted to the optical modulating section, based on the light emission brightness value determined in the brightness determining section.

15. A display apparatus comprising:
the backlight apparatus according to claim 4;
the optical modulating section;
an image signal correcting section that corrects an image signal inputted to the optical modulating section, based on the light emission brightness value determined in the brightness determining section; and
a delay section that delays the image signal outputted from the image signal correcting section, by a predetermined period.
